(19) United States
(12) Patent Application Publication
(10) Pub. No.: US 2024/0223871 A1
(43) Pub. Date: Jul. 4, 2024

(54) GENERATION AND DELIVERY OF A COMPOSITE CONTENT ITEM ASSOCIATED WITH A PRIMARY CONTENT ITEM

(71) Applicant: Meta Platforms, Inc., Menlo Park, CA (US)

(72) Inventors: Randall Charles BENNETT, New Rochelle, NY (US); Sten SISCO, Owls Head, ME (US); Ram POPAT, London (GB); Neil O'CONNOR, Stafford (GB); Kanika KUMAR, London (GB); Latika SHARMA, Chandigarh (IN); Nicolas Jean Claude ROBIN, Margate (GB)

(73) Assignee: Meta Platforms, Inc., Menlo Park, CA (US)

(21) Appl. No.: 18/545,589

(22) Filed: Dec. 19, 2023

Related U.S. Application Data
(60) Provisional application No. 63/436,360, filed on Dec. 30, 2022.
(60) Provisional application No. 63/436,366, filed on Dec. 30, 2022.
(60) Provisional application No. 63/436,373, filed on Dec. 30, 2022.

(51) Int. Cl. H04N 21/81; H04N 21/431; H04N 21/4725

(52) U.S. Cl. CPC H04N 21/812; H04N 21/4316; H04N 21/4725

(57) ABSTRACT

According to examples, a system for providing generation and delivery of a composite content item associated with a primary content item is described. The system may include a processor and a memory storing instructions. The processor, when executing the instructions, may cause the system to access a primary content item, provide a supplemental content item associated with the primary content item, and generate a composite item based on the primary content item and the supplemental content item. The processor, when executing the instructions, may then enable sponsorship of the composite content item and enable publication of the composite content item.

### PRIORITY

This patent application claims priority to U.S. Provisional Patent Application No. 63/436,360, entitled “Generation and Delivery of a Composite Content Item associated with a Primary Content Item,” filed on Dec. 30, 2022, U.S. Provisional Patent Application No. 63/436,366, entitled “Generating and Publishing Transactional Content Items based on Original Content Items,” filed on Dec. 30, 2022, and U.S. Provisional Patent Application No. 63/436,373, entitled “Systems and Methods for Generating and Publishing Transactional Content Items based on Original Content Items,” filed on Dec. 30, 2022.

### TECHNICAL FIELD

This patent application relates generally to generation and delivery of digital content, and more specifically, to systems and methods for generation and delivery of a composite content item associated with a primary content item and generation and delivery of a transactional content item based on an original content item.

### BACKGROUND

With recent advances in technology, prevalence and proliferation of content creation and delivery has increased greatly in recent years. Content creators, such as vendors looking to advertise goods or services, are continuously looking for ways to deliver more appealing content.

For some content creators, digital advertising may provide an appealing option due to its efficient and versatile nature. Digital advertising may be efficient in that may enable a content creator to target particular audiences that may be predisposed. Digital advertising may be versatile in that it may be deployed over a variety of content platforms.

However, digital advertising may also come with its own drawbacks. For example, creation of digital advertising content may sometimes require significant amounts of “post-processing” (e.g., editing, addition of visual or audio effects, formatting, etc.). However, in many instances, content creators may not have skills required to generate professional-quality content. Moreover, enlisting help from those with the required skills may be costly and time-consuming as well.

For some content creators, short-form video may provide an appealing option due to its efficient and versatile nature. Short-form video may be efficient in that may be relatively easy for content creators to create, and may be easy for receiving users to consume.

However, short-form video may also come with its own drawbacks. Specifically, in many instances, short-form video may be difficult to monetize. For example, monetization of short-form video may sometimes require significant amounts of “post-processing” (e.g., editing, addition of visual or audio effects, formatting, etc.). However, in many instances, content creators may not have skills required to generate professional-quality content. Moreover, enlisting help from those with the required skills may be costly and time-consuming as well.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIGS. 1A-1B illustrates a block diagram of a system environment, including a system, to provide generation and publishing of composite content items based on original content items, according to an example.

FIG. 1C illustrates one or more interface elements associated with a supplemental content item that may be displayed in a composite content item, according to an example.

FIG. 1D illustrates an interface including one or more interface elements associated with notifying a creating user that a composite content item may be available for publication, according to an example.

FIG. 1E illustrates one or more interface elements associated with listing and searching of one or more primary content items that may be utilized to generate a composite content item, according to an example.

FIG. 1F illustrates one or more interface elements associated with providing information associated with one or more primary content items, according to an example.

FIG. 1G illustrates one or more interface elements associated with effecting a bidding process to determine sponsorship of an associated composite content item, according to an example.

FIG. 1H illustrates a composite content item that may be distributed to a social media platform, according to an example.

FIG. 2 illustrates a block diagram of a computer system to generate and publish composite content items based on primary content items, according to an example.

FIG. 3 illustrates a method for generating and publishing composite content items based on primary content items, according to an example.

FIG. 4A illustrates a block diagram of a system environment, including a system, to provide generation and publishing of transactional content items based on original content items, according to an example.

FIG. 4B illustrates one or more interface elements associated with a digital storefront, according to an example.

FIG. 4C illustrates one or more interface elements associated with a product page, according to an example.

FIG. 4D illustrates one or more interface elements associated with selection of an image, according to an example.

FIG. 4E illustrates one or more interface elements associated with addition of audio to a content item, according to an example.

FIG. 4F illustrates one or more interface elements associated with indicating generation of a content item, according to an example.

FIG. 4G illustrates one or more interface elements associated with providing search of transactional content items, according to an example.

FIG. 4H illustrates one or more interface elements associated with providing transactional content items based on location, according to an example.

FIG. 5 illustrates a method for generating and publishing transactional content items based on original content items, according to an example.

FIG. 6A illustrates a block diagram of a system environment, including a system, to provide generation and publishing of transactional content items based on original content items, according to an example.

FIG. 6B illustrates a user interface providing generation and publishing of transactional content items based on original content items, according to an example.

FIG. 6C illustrates a user interface providing generation and publishing of transactional content items based on original content items, according to an example.

FIG. 6D illustrates a user interface providing generation and publishing of transactional content items based on original content items, according to an example.

FIG. 6E illustrates a user interface providing generation and publishing of transactional content items based on original content items, according to an example.

FIG. 7 illustrates a method for generating and publishing transactional content items based on original content items, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

With the proliferation of different types of digital content delivery mechanisms (e.g., mobile phone, portable computing devices, tablet devices, etc.), it has become crucial that content providers, such as vendors looking to advertise a good or service, engage users with content of interest. As a result, content providers are continuously looking for ways to deliver more appealing content.

In some instances, digital advertising may be an appealing option due to its immediate, inexpensive, and versatile nature. For example, small businesses with limited budgets may find digital advertising appealing because it may offer an opportunity to direct limited resources in a highly-targeted manner to potential customers. So, in one example, a vendor may generate an advertising content item to engage potential customers and may distribute the advertising content item over a content platform (e.g., a social media platform) to make users aware of their product.

However, digital advertising may also come with its own drawbacks. For example, a content item produced by a commercial entity (e.g., a company with a brand associated with one or more products) may not be as appealing as another content item produced by a third party. In these instances, it may be in the commercial entity's interest to utilize the another content item produced by the third party in order to advertise its products. However, it may be difficult for the commercial entity to secure one or more rights to use said another content item.

Systems and methods described may provide generation and delivery of a composite content item including a supplemental content item and based on a primary content item. As used herein, a “primary content item” may include any content item that may be delivered to a user. An example of a primary content item may be a short-form video associated with an item of clothing. As used herein, a “supplemental content item” may include any content item that may be associated with a primary content item. An example of a supplemental content item may be a banner or a sticker that may be displayed in conjunction with playback of a short-form video. As used herein, a “composite content item” may include any content item that may be generated based on a primary content item and may include a supplemental content item.

Furthermore, in some examples, the systems and methods may provide one or more user interfaces that may enable generation and delivery of supplemental content items associated with primary content items. That is, in some examples, by providing simple user interface elements to generate one or more composite content items, the systems and methods may facilitate related digital transactions efficiently.

In some examples, the systems and methods may generate and deliver a composite content item associated with a content item in order to facilitate a transaction. In some examples, the transaction may or may not be related to either the supplemental content item or the primary content item.

The systems and methods described herein may be implemented in various contexts. So, in some examples, a commercial entity (e.g., a large corporation managing a well-known “brand” of products and services) may utilize the systems and methods described herein to generate and distribute content items (e.g., advertising videos) efficiently and inexpensively. For example, in some instances, a commercial entity may be presented with one or more content items that may include supplemental content items that be utilized by the commercial entity to advertise products or services.

In these instances, the systems and methods may enable the commercial entity to generate one or more content items (e.g., short-form videos), each associated with the multiple products and services, wherein the one or more transactional content items may include supplemental content items directed each of the multiple products and services.

As such, in some instances, the commercial entity may reach new customers that otherwise may not have been reached. More specifically, for example, where a content item may or may not have directly related to a product or services, the systems and methods may enable an associated entity to provide supplemental content items that may publish (e.g., advertise) the entity's products or services directly. Accordingly, in some examples, the systems and methods may enable customers with lesser direct intent to conduct transaction for products and services that were previously unknown to them.

In addition, the systems and methods may benefit content creators as well. Specifically, by providing simple user interface elements that may enable content creators to efficiently create content items that may easily be consumable by viewers. Furthermore, it may be appreciated that the systems and methods described may enable content creators to more readily monetize their content, in that the systems and methods may “narrow the gap” between content creation and content monetization.

In some examples, the systems and methods may automate processes associated with monetization, such as determining which primary content items may benefit from addition of supplemental content items and which supplemental content items should be added to a primary content item, and therefore may make it significantly easier for content creators to benefit from their creations. It should be appreciated that while the examples described herein may relate primarily to advertising and content generation in advertising, the systems and methods described may have numerous other applications as well.

In some examples, the information associated with generation and publication of composite content items may be gathered and utilized according to various policies. For example, in particular embodiments, privacy settings may allow users to review and control, via opt in or opt out selections, as appropriate, how their data may be collected, used, stored, shared, or deleted by the systems and methods or by other entities (e.g., other users or third-party systems), and for a particular purpose. The systems and methods may present users with an interface indicating what data is being collected, used, stored, or shared by the systems and methods described (or other entities), and for what purpose. Furthermore, the systems and methods may present users with an interface indicating how such data may be collected, used, stored, or shared by particular processes of the systems and methods or other processes (e.g., internal research, advertising algorithms, machine-learning algorithms). In some examples, a user may have to provide prior authorization before the systems and methods may collect, use, store, share, or delete data associated with the user for any purpose.

Moreover, in particular embodiments, privacy policies may limit the types of data that may be collected, used, or shared by particular processes of the systems and methods for a particular purpose (as described further below). In some examples, the systems and methods may present users with an interface indicating the particular purpose for which data is being collected, used, or shared. In some examples, the privacy policies may ensure that only necessary and relevant data may be collected, used, or shared for the particular purpose, and may prevent such data from being collected, used, or shared for unauthorized purposes.

Also, in some examples, the collection, usage, storage, and sharing of any data may be subject to data minimization policies, which may limit how such data that may be collected, used, stored, or shared by the systems and methods, other entities (e.g., other users or third-party systems), or particular processes (e.g., internal research, advertising algorithms, machine-learning algorithms) for a particular purpose. In some examples, the data minimization policies may ensure that only relevant and necessary data may be accessed by such entities or processes for such purposes.

In addition, it should be appreciated that in some examples, the deletion of any data may be subject to data retention policies, which may limit the duration such data that may be user or stored by the systems and methods (or by other entities), or by particular processes (e.g., internal research, advertising algorithms, machine-learning algorithms, etc.) for a particular purpose before being automatically deleted, de-identified, or otherwise made inaccessible. In some examples, the data retention policies may ensure that data may be accessed by such entities or processes only for the duration it is relevant and necessary for such entities or processes for the particular purpose. In particular examples, privacy settings may allow users to review any of their data stored by the systems and methods or other entities (e.g., third-party systems) for any purpose, and delete such data when requested by the user.

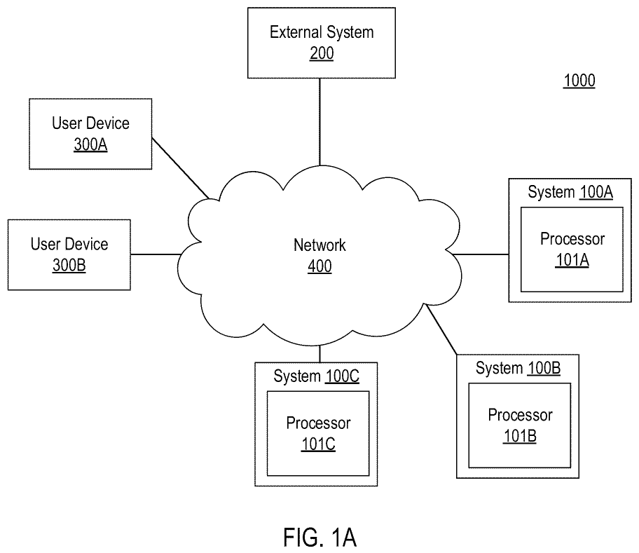

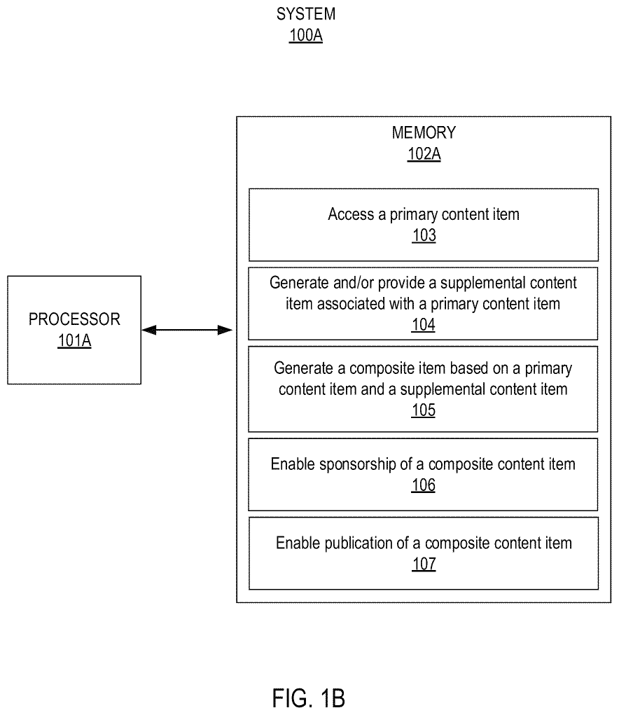

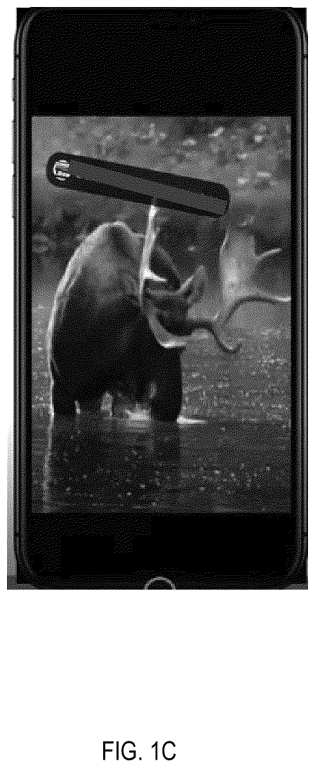

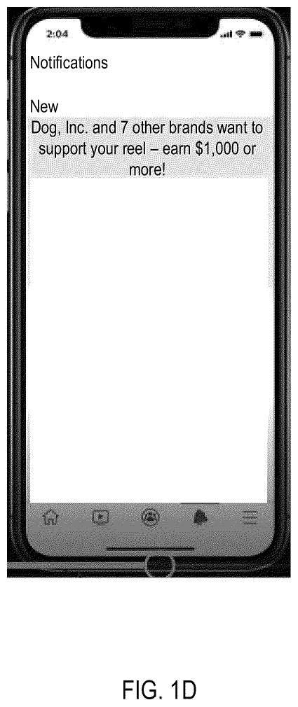

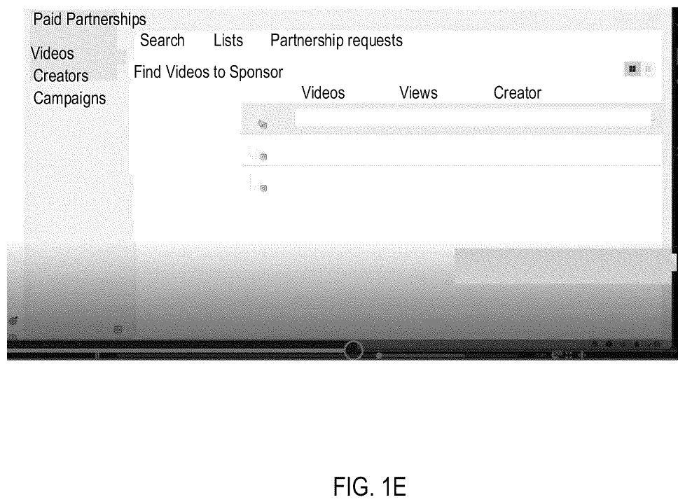

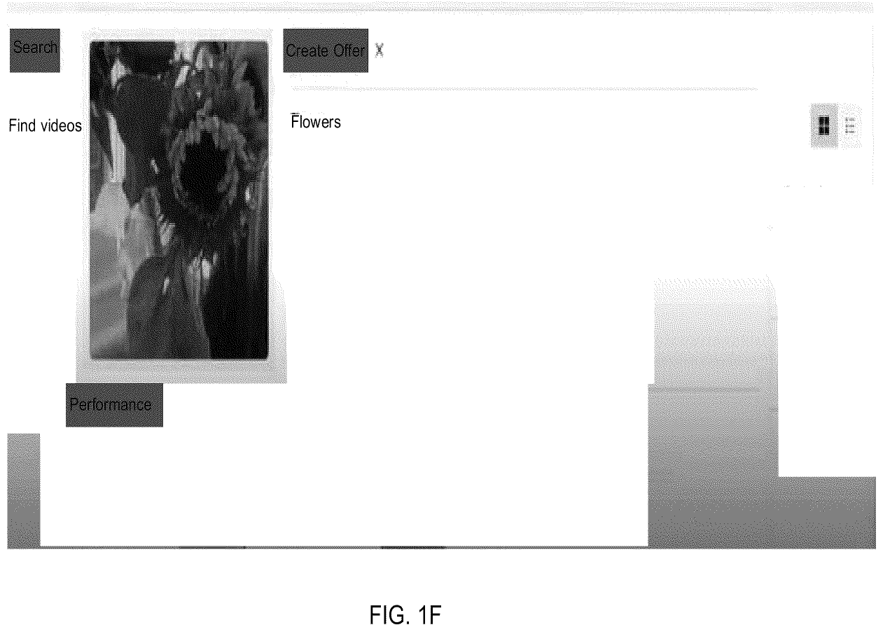

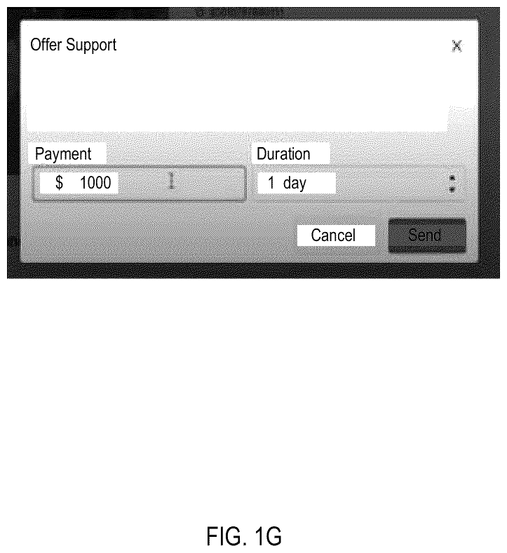

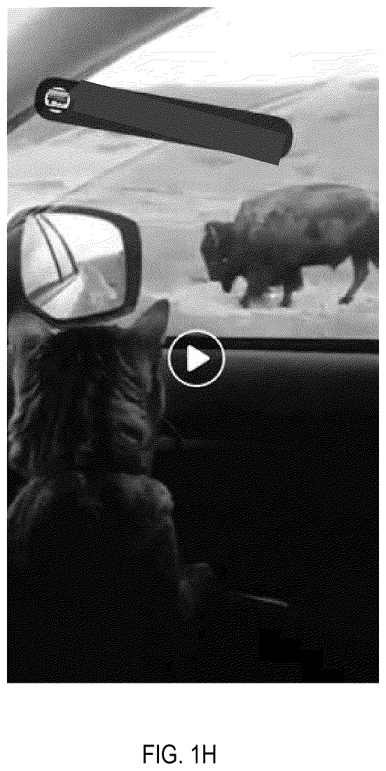

Reference is now made to FIGS. 1A-1B. FIG. 1A illustrates a block diagram of a system environment, including a system, that may be implemented to provide generation and delivery of a composite content item associated with a primary content item, according to an example. FIG. 1B illustrates a block diagram of the system that may be implemented to provide generation and delivery of a composite content item associated with a primary content item, according to an example.

As will be described in the examples below, one or more of systems 100A-100C, external system 200, user devices 300A-300B and system environment 1000 shown in FIGS. 1A-1B may be operated by a service provider to provide generation and delivery of a composite content item associated with a primary content item. It should be appreciated that one or more of the systems 100A-100C, the external system 200, the user devices 300A-300B and the system environment 1000 depicted in FIGS. 1A-1B may be provided as examples. Thus, one or more of the systems 100A-100C, the external system 200 the user devices 300A-300B and the system environment 1000 may or may not include additional features and some of the features described herein may be removed and/or modified without departing from the scopes of the systems 100A-100C, the external system 200, the user devices 300A-300B and the system environment 1000 outlined herein. Moreover, in some examples, the systems 100A-100C, the external system 200, and/or the user devices 300A-300B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 1A-1B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the systems 100A-100C, the external system 200, the user devices 300A-300B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the systems 100A-100C, the user devices 300A-300B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to generation and delivery of content (e.g., user information, etc.).

In some examples, and as will be described in further detail below, the user devices 300A-300B may be utilized to, among other things, provide generation and delivery of a composite content item associated with a primary content item. In some examples, the user devices 300A-300B may be electronic or computing devices configured to transmit and/or receive data. In this regard, each of the user devices 300A-300B may be any device having computer functionality, such as a television, a radio, a smartphone, a tablet, a laptop, a watch, a desktop, a server, or other computing or entertainment device or appliance. In some examples, the user devices 300A-300B may be mobile devices that are communicatively coupled to the network 400 and enabled to interact with various network elements over the network 400. In some examples, the user devices 300A-300B may execute an application allowing a user of the user devices 300A-300B to interact with various network elements on the network 400. Additionally, the user devices 300A-300B may execute a browser or application to enable interaction between the user devices 300A-300B and the systems 100A-100C via the network 400. In some examples, and as will described further below, a client may utilize the user devices 300A-300B to access a browser and/or an application interface for providing generation and delivery of a composite content item associated with a primary content item.

Moreover, in some examples and as will also be discussed further below, the user devices 300A-300B may be utilized by a user viewing content (e.g., advertisements) distributed by a service provider, wherein information relating to the user may be stored and transmitted by the user devices 300A to other devices, such as the external system 200.

The system environment 1000 may also include the network 400. In operation, one or more of the systems 100A-100C, the external system 200 and the user devices 300A-300B may communicate with one or more of the other devices via the network 400. The network 400 may be a local area network (LAN), a wide area network (WAN), the Internet, a cellular network, a cable network, a satellite network, or other network that facilitates communication between, the systems 100A-100C, the external system 200, the user devices 300A-300B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 1A, it should be appreciated that, in some examples, the network 400 may include a plurality of interconnected networks as well.

It should be appreciated that in some examples, and as will be discussed further below, the systems 100A-100C may be configured to utilize artificial intelligence (AI) based techniques and mechanisms to provide generation and delivery of a composite content item associated with a primary content item. Details of the systems 100A-100C and its operation within the system environment 1000 will be described in more detail below.

As shown in FIGS. 1A-1B, the system 100A may include processor 101A and the memory 102A. In some examples, the processor 101A may be configured to execute the machine-readable instructions stored in the memory 102A. It should be appreciated that the processor 101A may be a semiconductor-based microprocessor, a central processing unit (CPU), an application specific integrated circuit (ASIC), a field-programmable gate array (FPGA), and/or other suitable hardware device.

In some examples, the memory 102A may have stored thereon machine-readable instructions (which may also be termed computer-readable instructions) that the processor 101A may execute. The memory 102A may be an electronic, magnetic, optical, or other physical storage device that contains or stores executable instructions. The memory 102A may be, for example, random access memory (RAM), an Electrically Erasable Programmable Read-Only Memory (EEPROM), a storage device, an optical disc, or the like. The memory 102A, which may also be referred to as a computer-readable storage medium, may be a non-transitory machine-readable storage medium, where the term “non-transitory” does not encompass transitory propagating signals. It should be appreciated that the memory 102A may be provided as an example. Thus, the memory 102A may or may not include additional features, and some of the features described herein may be removed and/or modified without departing from the scope of the memory 102A outlined herein.

It should be appreciated that, and as described further below, the processing performed via the instructions on the memory 102A may or may not be performed, in part or in total, with the aid of other information and data, such as information and data provided by the external system 200 and/or the user devices 300A-300B. Moreover, and as described further below, it should be appreciated that the processing performed via the instructions on the memory 102A may or may not be performed, in part or in total, with the aid of or in addition to processing provided by other devices, including for example, the external system 200 and/or the user devices 300A-300B.

In some examples, the memory 102A may store instructions, which when executed by the processor 101A, may cause the processor to: access a primary content item, generate and/or provide a supplemental content item associated with a primary content item, generate a composite content item based on a primary content item and a supplemental content item, enable sponsorship of a composite content item, and enable publication of a composite content item.

In some examples, and as discussed further below, the instructions 103-107 on the memory 102A may be executed alone or in combination by the processor 101A to provide generating and publishing of composite content items based on original content items. In some examples, the instructions 103-107 may be implemented in association with a content platform configured to provide content for users, while in other examples, the instructions 103-107 may be implemented as part of a stand-alone application.

Additionally, although not depicted, it should be appreciated that to provide generating and publishing of composite content items based on original content items, instructions 103-107 may utilize various artificial intelligence (AI) based machine learning (ML) tools. For instance, these artificial intelligence (AI) based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should also be appreciated that the system 100A may provide other types of machine learning (ML) approaches, such as reinforcement learning, feature learning, anomaly detection, etc.

In some examples, the instructions 103 may access a primary content item. So, in some examples, the instructions 103 may access a short-form video (e.g., a video content item that may be one minute in length) to be utilized as a primary content item. One example of such a short-form video may be a portion (e.g., a clip) of a shopping livestream video from a social application influencer. Another example may be a humorous short-form video produced by an individual social application user that may relate to a particular one of a company's products.

In some examples, the instructions 103 may analyze a primary content item. In particular, in some examples, the instructions 103 may analyze the primary content item to determine one or more characteristics of the primary content item. As used herein, a “characteristic” of a primary content item may include any aspect associated with the primary content item.

In some examples, to analyze a characteristic of a primary content item, the instructions 103 may determine one or more products or services associated with a primary content item that may be a basis of a supplemental content item. In particular, in some examples, the instructions 103 may determine one or more products or services associated with the primary content item that may be suggested to be a basis of a supplemental content item. In other examples, to analyze a characteristic of a primary content item, the instructions 103 may determine a subject matter associated with the primary content item. In still other examples, the instructions 103 may analyze the primary content item to determine one or more entities (e.g., a person, a corporation, etc.) associated with the primary content item.

As will be discussed in further detail below, in some examples, results of an analysis of a primary content item via the instructions 103 may be utilized to determine a supplemental content item that may be associated. It may be appreciated that in order to determine one or more products or services associated with a primary content item that may be a basis of a supplemental content item (e.g., automatically), the instructions 103 may be configured to implement one or more aspects of neural networking, artificial intelligence (AI), and machine learning (ML).

In some examples, the instructions 104 may generate and/or provide a supplemental content item associated with a primary content item. In particular, in some examples, the instructions 104 may utilize results of an analysis (e.g., via the instructions 103) of the primary content item to generate, provide, or determine a supplemental content item to associate with the primary content item.

In some examples, the instructions 104 may combine a supplemental content item provided via the instructions 104 with a primary content item to generate a composite content item. So, in one example, where the primary content item may be a short-form video of a father showing a daughter how to make spaghetti and the supplemental content item may be a sticker including a logo of a well-known pasta company, the composite content item may be a short-form video of the father showing a daughter how to make spaghetti with a sticker including a logo of a well-known pasta company (e.g., located in the upper right corner of the short-form video).

It may be appreciated that, in some examples, a supplemental content item determined via the instructions 104 may take any form of a content item. So, in some examples, the instructions 104 may utilize one or more interface elements that may be utilized to generate the supplemental content item. In one example, the supplemental content item generated via the instructions 104 may take the form of a banner that may be displayed over a primary content item. In another example, the supplemental content item generated via the instructions 104 may take the form of a sticker that may be displayed over a primary content item. FIG. 1C illustrates one or more interface elements (e.g., a sticker) associated with a supplemental content item that may be displayed over a primary content item (e.g., a short-form video).

In some examples, a supplemental content item provided via the instructions 104 may enable an action to be taken (e.g., by a viewing user). So, for example, in some examples, the supplemental content item may be a selectable button that, when selected by a viewing user, may enable access a new interface or interface element (e.g., an informational website related to a product in a primary content item, a product checkout or shopping cart, etc.). It may be appreciated that the new interface or interface element, in some examples, may enable a viewing user to conduct a (e.g., related) transaction.

In some examples, the instructions 105 may generate a composite item based on a primary content item and a supplemental content item. In addition, in some examples, the instructions 105 may provide a notification (e.g., to a creating user) that a composite content item may be available for publishing with the primary content item (e.g., “Your reel is ready to view.”). As used herein, the terms “reel” and “short-form video” may be used interchangeably. FIG. 1D illustrates an interface including one or more interface elements associated with notifying a creating user that a composite content item may be available for publication.

In some examples and as will be discussed further below, providing a notification to a creating user that a composite content item may be available via the instructions 105 may include, among other things, providing one or more interface elements that may relate to providing a preview (e.g., audio or video preview) of the composite content item and enabling a creating user to provide permission to publication of the composite content item.

In some examples, the instructions 106 may enable sponsorship of a composite content item. As used herein, “sponsorship” may include any support or incentive (e.g., a payment) that may be offered by a first party (e.g., user) to a second party (e.g., user) in association with publication of a composite content item.

So, in some examples, a first entity (e.g., a corporation offering one or more products associated with a brand) may seek to sponsor a primary content item published by a second entity (e.g., a user of a social application publishing a do-it-yourself (DIY) video). In these examples and as will be discussed further below, the instructions 106 may enable the first entity (e.g., a sponsoring user) to sponsor the primary content item created by the second entity (e.g., a user that created a short-form video).

In some examples and as will be discussed further below, the instructions 106 may provide a user interface including one or more user interface elements associated with enabling a user to sponsor a primary content item. So, in some examples, the instructions 106 may provide a user interface that may include one or more primary content items (and associated information such as username, average reach, etc.) that may be available for sponsorship to a sponsoring user. As used herein, a “sponsoring user” may include any entity (e.g., a user, a corporation, etc.) that may wish to associate a supplemental content item with a primary content item in order to generate and/or publish a composite content item. So, in another example and as will be discussed in further detail below, the instructions 106 may provide a user interface including one or more user interface elements that may enable a sponsoring user to create an offer that may be reviewed by a creating user (e.g., of a primary content item) to determine whether a partnership between the creating user and the sponsoring user (e.g., to distribute a composite content item) should take place. In yet another example, the instructions 106 may provide a user interface including one or interface elements that may enable a creating user to accept an offer from a sponsoring user to partner with the sponsoring user regarding a composite content item to be distributed.

In some examples, sponsoring of the primary content item via the instructions 106 may include providing a supplemental content item (e.g., by a sponsoring user) to generate a composite content item. So, in the example described above where the primary content item may be a short-form video of a father showing a daughter how to make spaghetti, the instructions 106 may enable the pasta company to add a supplemental content item that may be a sticker of the logo of the pasta company to generate the composite content item.

It may be appreciated that, in some examples, a primary content item that an entity may seek to sponsor may be related to a supplemental content item (e.g., “endemic”) that the entity may wish to provide. One such example may be of the well-known pasta company seeking to sponsor a short-form video of the father showing a daughter how to make spaghetti using a sticker (e.g., a supplemental content item) including a logo of the pasta company.

However, in other examples, the primary content item that an entity may seek to sponsor may not necessarily be related (e.g., via subject matter) to a supplemental content item (e.g., “non-endemic”) that the entity may wish to provide. One such example may be a primary content item that may be a short-form video of a sports highlight, where an entity that may be an automobile company may wish to sponsor using a banner (e.g., a supplemental content item) announcing a launch of a new vehicle model.

In some examples, the instructions 106 may implement a vetting process with regard to one or more of a creating user (e.g., of a primary content item) and a sponsoring user that may be seeking to sponsor an associated content item. So, in some examples, the instructions 106 may be configured to review one or more aspects of the parties involved to provide information that may enable the parties to determine whether they should partner.

It may also be appreciated that, in some examples, to enable sponsorship of a composite content item, the instructions 106 may provide a user interface including one or more user interface elements directed to enabling the sponsorship of the composite content item. So, in some examples, the instructions 106 may provide user interface elements that may enable searching of one or more primary content items. FIG. 1E illustrates one or more interface elements associated with listing and searching of one or more primary content items that may be utilized to generate a composite content item. It may be appreciated that to provide suggested primary content items to a user (e.g., a sponsoring user), the instructions 104 may be configured to implement one or more aspects of neural networking, artificial intelligence (AI), and machine learning (ML).

Also, in some examples, the instructions 106 may provide user interface elements that may provide information associated with the one or more primary content items. For example, the types of information may include an identity (e.g., username) of a creator associated with the primary content item, a number of views for the primary content item, or pricing information associated with the primary content item. FIG. 1F illustrates one or more interface elements associated with providing information associated with one or more primary content items.

In addition, in some examples, the instructions 106 may provide user interface elements that may enable an entity (e.g., a sponsoring user) to effect a bidding process to determine sponsorship of an associated composite content item. So, for example, in some instances, the instructions 106 may enable one or more (potential) sponsoring entities to input a currency amount that they may be willing to pay per one thousand (1000) impressions (e.g., CPM) of the composite content item. In some examples, the sponsoring user entity that may be willing to pay (e.g., bid) the most may “win” the opportunity to sponsor the associated primary content item. FIG. 1G illustrates one or more interface elements associated with effecting a bidding process to determine sponsorship of an associated composite content item.

In some examples, the instructions 107 may enable publication of a composite content item. In particular, in some examples, the instructions 107 may distribute the composite content item to one or more destination devices for playback (e.g., by a viewing user). It may be appreciated that the instructions 107 may distribute the composite content item to one or more content platforms, such as a social media platform or a content sharing platform. FIG. 1H illustrates an example of a composite content item that may be distributed to a social media platform.

It may be appreciated that, upon generation of a composite content item and/or sponsorship of a composite content item (e.g., via the instructions 103-106), the instructions 107 may enable “organic” distribution of the composite content item on one or more content platforms. That is, in some examples, the instructions 107 may be configured to distribute the composite content item to one or more destination devices and associated users (e.g., of a social application) via one or more distribution algorithms. So, for example, in some instances, a distribution algorithm may utilize preferences, content (e.g., subject matter), and/or “virality” to distribute composite content item to one or more users that may be likely to consume the composite content item.

However, it may also be appreciated that, in addition to “organic” distribution of a composite content item, the instructions 107 may enable “directed” distribution of the composite content item on one or more content platforms. In particular, in some examples, the instructions 107 may be configured to distribute the composite content item to one or more destination devices and associated users (e.g., of a social application) based on a directed distribution. So, in one example, a sponsoring entity (e.g., a company) may pay to have the composite content item distributed to one or more destination devices and associated users via one or more distribution algorithms. That is, in some examples, the instructions 107 may enable distribution of the composite content item to be treated as “paid advertising” on the one or more content platforms, wherein the sponsoring user may enjoy “co-branded” content distribution via a creating user's (e.g., of the primary content item) distribution channel.

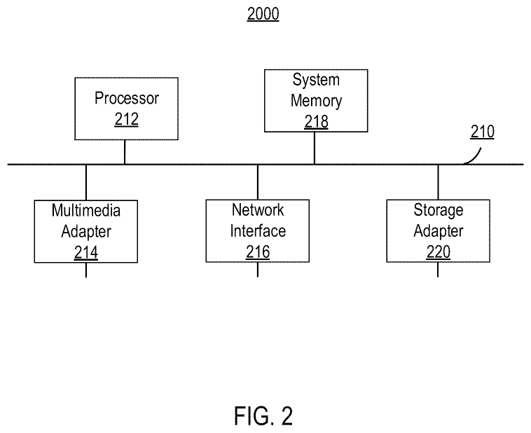

FIG. 2 illustrates a block diagram of a computer system to generate and publish composite content items based on primary content items, according to an example. In some examples, the system 2000 may be associated the system 100A to perform the functions and features described herein. The system 2000 may include, among other things, an interconnect 210, a processor 212, a multimedia adapter 214, a network interface 216, a system memory 218, and a storage adapter 220.

The interconnect 210 may interconnect various subsystems, elements, and/or components of the external system 200. As shown, the interconnect 210 may be an abstraction that may represent any one or more separate physical buses, point-to-point connections, or both, connected by appropriate bridges, adapters, or controllers. In some examples, the interconnect 210 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 210 may allow data communication between the processor 212 and system memory 218, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 212 may be the central processing unit (CPU) of the computing device and may control overall operation of the computing device. In some examples, the processor 212 may accomplish this by executing software or firmware stored in system memory 218 or other data via the storage adapter 220. The processor 212 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 214 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 216 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 216 may provide a direct or indirect connection from one network element to another, and facilitate communication and between various network elements.

The storage adapter 220 may connect to a standard computer-readable medium for storage and/or retrieval of information, such as a fixed disk drive (internal or external).

Many other devices, components, elements, or subsystems (not shown) may be connected in a similar manner to the interconnect 210 or via a network (e.g., network 400 of FIG. 1A). Conversely, all of the devices shown in FIG. 2 need not be present to practice the present disclosure. The devices and subsystems can be interconnected in different ways from that shown in FIG. 2. The operating system provided on systems 100A-100C may be MS-DOS, MS-WINDOWS, OS/2, OS X, IOS, ANDROID, UNIX, Linux, or another operating system.

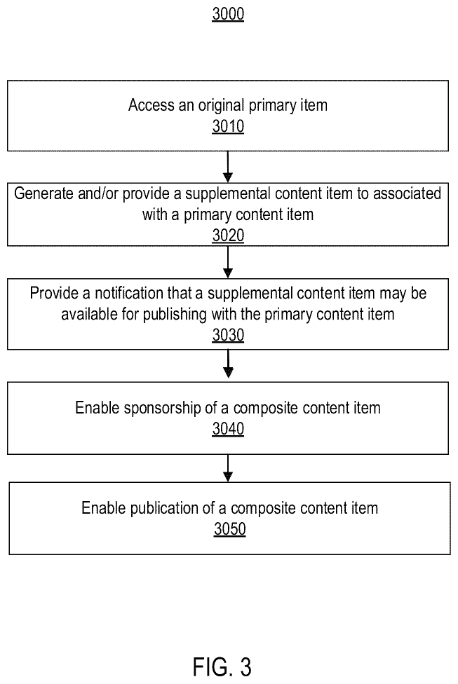

FIG. 3 illustrates a method for generate and publish composite content items based on primary content items, according to an example. The method 3000 is provided by way of example, as there may be a variety of ways to carry out the method described herein. Each block shown in FIG. 3 may further represent one or more processes, methods, or subroutines, and one or more of the blocks may include machine-readable instructions stored on a non-transitory computer-readable medium and executed by a processor or other type of processing circuit to perform one or more operations described herein.

Although the method 3000 is primarily described as being performed by system 100A as shown in FIGS. 1A-1B, the method 3000 may be executed or otherwise performed by other systems, or a combination of systems. It should be appreciated that, in some examples, to provide generating and publishing of composite content items based on original content items, the method 3000 may be configured to incorporate artificial intelligence (AI) or deep learning techniques, as described above. It should also be appreciated that, in some examples, the method 3000 may be implemented in conjunction with a content platform (e.g., a social media platform) to generate and deliver content.

Reference is now made with respect to FIG. 3. At 3010, in some examples, the processor 101A may access a primary content item. One example of such a short-form video may be a portion (e.g., a clip) of a shopping livestream video from a social application influencer. In some examples, the processor 101A may analyze a primary content item. In some examples, to analyze a characteristic of a primary content item, the processor 101A may determine one or more products or services associated with a primary content item that may be a basis of a supplemental content item.

At 3020, in some examples, the processor 101A may generate and/or provide a supplemental content item to associated with a primary content item. In some examples, the processor 101A may combine a supplemental content item provided via the processor 101A with a primary content item to generate a composite content item. It may be appreciated that, in some examples, a supplemental content item determined via the processor 101A may take any form of a content item. In some examples, a supplemental content item provided via the processor 101A may enable an action to be taken (e.g., by a viewing user).

At 3030, in some examples, upon generation of a supplemental content item associated with a primary content item, the processor 101A may provide a notification (e.g., to a creating user) that a supplemental content item may be available for publishing with the primary content item. In some examples and as will be discussed further below, providing a notification to a creating user that a composite content item may be available via the processor 101A may include, among other things, providing one or more interface elements that may relate to providing a preview (e.g., audio or video preview) of the composite content item and enabling a creating user to provide permission to publication of the composite content item.

At 3040, in some examples, the processor 101A may enable sponsorship of a composite content item. In some examples, the processor 101A may provide a user interface including one or more user interface elements associated with enabling a user to sponsor a primary content item. In another example, the processor 101A may provide a user interface including one or more user interface elements that may enable a sponsoring user to create an offer that may be reviewed by a creating user (e.g., of a primary content item) to determine whether a partnership between the creating user and the sponsoring user (e.g., to distribute a composite content item) should take place. It may be appreciated that, in some examples, a primary content item that an entity may seek to sponsor may be related to a supplemental content item (e.g., “endemic”) that the entity may wish to provide. However, in other examples, the primary content item that an entity may seek to sponsor may not necessarily be related (e.g., via subject matter) to a supplemental content item (e.g., “non-endemic”) that the entity may wish to provide. It may also be appreciated that, in some examples, to enable sponsorship of a composite content item, the processor 101A may provide a user interface including one or more user interface elements directed to enabling the sponsorship of the composite content item.

At 3050, in some examples, the processor 101A may enable publication of a composite content item. In particular, in some examples, the processor 101A may distribute the composite content item to one or more destination devices for playback.

It may be appreciated that, upon generation of a composite content item and/or sponsorship of a composite content item, the processor 101A may enable “organic” distribution of the composite content item on one or more content platforms. However, it may also be appreciated that, in addition to “organic” distribution of a composite content item, the processor 101A may enable “directed” distribution of the composite content item on one or more content platforms.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

Advances in content management and media distribution are causing users to engage with content on or from a variety of content platforms. As used herein, a “user” may include any user of a computing device or digital content delivery mechanism who receives or interacts with delivered content items, which may be visual, non-visual, or a combination thereof. Also, as used herein, “content”, “digital content”, “digital content item” and “content item” may refer to any digital data (e.g., a data file). Examples include, but are not limited to, digital images, digital video files, digital audio files, and/or streaming content. Additionally, the terms “content”, “digital content item,” “content item,” and “digital item” may refer interchangeably to themselves or to portions thereof.

With the proliferation of different types of digital content delivery mechanisms (e.g., mobile phone, portable computing devices, tablet devices, etc.), it has become crucial that content providers, such as vendors looking to advertise a good or service, engage users with content of interest. As a result, content providers are continuously looking for ways to deliver more appealing content.

In some instances, short-form video may be an appealing option due to its immediate, inexpensive, and versatile nature. As used herein, “short-form video” may include any video content that may span a time of a few of seconds to ten minutes.

For example, small businesses with limited budgets may find short-form video appealing because it may offer an opportunity to reach potential customers in a very convenient manner. So, in one example, a vendor may generate an advertising content item via short-form video to engage potential customers, and may distribute the short-form video over a content platform (e.g., a social media platform) to make users aware of their product or service. Indeed, in some instances, video marketing (e.g., a viewing of a short-form video) associated with a product or service can lead to significant increase in transactional “conversions.”

However, short-form video may also come with its own drawbacks. Specifically, in some instances, short-form video may be difficult to produce. For example, monetization of short-form video may sometimes require significant amounts of “post-processing” (e.g., editing, addition of visual or audio effects, formatting, etc.). However, in many instances, content creators may not have skills required to generate professional-quality content. In addition, examples of short-form video provided to viewing users, such as those provided in a user's content “feed” on a social application, may often not be of particular interest to a user, and therefore may result in lower engagement. Furthermore, in some instances, a short-form video that may be of interest to a user may also be difficult for the user to find (e.g., difficult to search and locate).

Systems and methods described may provide for generating and publishing transactional content items based on original content items. As used herein, an “original content item” may include any content item (e.g., audio content item, video content item) that may be used to generate another content item. An example of an original content item may be an image associated with an item of clothing. As used herein, a “transactional content item” may include any content item that may be based on an original content item, and may be associated with transaction that may be conducted. As will be discussed further below, an example of a transactional content item may be a short-form video including an original content item (e.g., an image of an item of clothing) that may contain one or more interface elements (e.g., a “buy it now” button) configured to facilitate a transaction based on the original content item. In some examples, the transaction may or may not be related to either the original content item.

In some examples and as will be discussed further below, the systems and methods may generate a transactional content item based on an original content item. In some examples, the transactional content item generated may be a short-form video based on a modified content item. In some examples, the systems and methods may generate a transactional content item to include one or more interface elements directed to facilitating one or more transactions. Also, in some examples, the systems and methods may automatically generate the transactional content item in conjunction with one or more neural networking, artificial intelligence (AI), and machine learning (ML) techniques.

In some examples, to generate a transactional content item, the systems and methods may determine one or more products or services associated with an original content item that may be a basis of the transactional content item. That is, in some examples, the one or more products or services may be associated with a creating user (e.g., as provided on an account or feature on a social application), wherein original content item (e.g., digital media) associated with the one or more products or services may be accessed and/or gathered to create the transactional content item. As used herein, a “creating user” may include any user that may be attempting to create a transactional content item based on an original content item, as described herein.

So, in one example, one or more products or services may be listed as images on an electronic product or service catalog or a digital “storefront” (e.g., one or more interface elements associated with facilitating a transaction for the creating user) as provided via the social application. It may be appreciated that, in some examples, in order to determine one or more products or services associated with an original content item that may be a basis of a transactional content item (e.g., automatically), the systems and methods may implement one or more aspects of neural networking, artificial intelligence (AI), and machine learning (ML) techniques.

In some examples, to generate a transactional content item, the systems and methods may enable a creating user to generate a modified content item. As used herein, a “modified content item” may be a content item that may be a modified version (e.g., modified by a creating user) of an original content item. In particular, in some examples, the systems and methods described may provide one or more interface that may enable a creating user to, among other things, “edit” an original content item to generate a modified content item.

In addition, in some examples, the systems and methods may provide one or more user interfaces that may enable generation and delivery of supplemental content items associated with original content items. As used herein, a “supplemental content item” may include any content item that may be used to supplement an aspect of a transactional content item to be generated. So, in one example, wherein the transaction content item may be a short-form video for a product, the supplemental content item may be a product description page (PDP) for the product.

In some examples, the systems and methods may facilitate related digital transactions efficiently by providing simple user interface elements to generate one or more transactional content items. Indeed, as will be discussed in further detail below, examples of these interface elements may be those associated with viewing a content item, editing of an original content item, generating a clip from an original content item, and generating a modified content item that may be used to generate a transactional content item.

The systems and methods described herein may be implemented in various contexts. So, in some examples, a commercial entity (e.g., a large corporation managing a well-known “brand” of products and services) may utilize the systems and methods described herein to generate and distribute content items (e.g., short-form advertising videos) efficiently and inexpensively.

In some instances, the systems and methods may enable the commercial entity to generate one or more transactional content items (e.g., short-form videos), each associated with the multiple products and services, wherein the one or more transactional content items may enable receiving users to conduct related transactions. Furthermore, in some examples, by providing simple user interface elements in the one or more transactional content items, the systems and methods may facilitate related transactions efficiently.

As such, in some instances, the commercial entity may reach new customers that otherwise may not have been reached. More specifically, for example, where a content item may or may not have directly related to a product or services, the systems and methods may enable an associated entity to provide supplemental content items that may publish (e.g., advertise) the entity's products or services directly. Accordingly, in some examples, the systems and methods may enable customers with lesser direct intent to conduct transaction for products and services that were previously unknown to them.

In some examples, the systems and methods may benefit content creators as well. So, in some examples, instead of merely providing a (static) listing of products via images and text, the systems and methods may enable content creators to create dynamic content items that may be utilized by the content creators to “tell their story.” In addition, in some examples, the content creators may utilize the systems and methods described herein to increase personalization and customization, and to utilize a multi-media approach in presenting their brands to potential customers.

Furthermore, by providing simple user interface elements that may enable content creators to efficiently create content items that may be more engaging and immersive for viewing users. It may be appreciated that the systems and methods described may enable content creators to more readily monetize their content, in that the systems and methods may “narrow the gap” between content creation and content monetization.

In some examples, the systems and methods may automate processes associated with monetization, such as determining which original content items may benefit from generation of transactional content items and which supplemental content items should be added to an original content item, and therefore may make it significantly easier for content creators to benefit from their creations. It should be appreciated that while the examples described herein may relate primarily to advertising and content generation in advertising, the systems and methods described may have numerous other applications as well.

In some examples, the information associated with generation and publication of transactional content items may be gathered and utilized according to various policies. For example, in particular embodiments, privacy settings may allow users to review and control, via opt in or opt out selections, as appropriate, how their data may be collected, used, stored, shared, or deleted by the systems and methods or by other entities (e.g., other users or third-party systems), and for a particular purpose. The systems and methods may present users with an interface indicating what data is being collected, used, stored, or shared by the systems and methods described (or other entities), and for what purpose. Furthermore, the systems and methods may present users with an interface indicating how such data may be collected, used, stored, or shared by particular processes of the systems and methods or other processes (e.g., internal research, advertising algorithms, machine-learning algorithms). In some examples, a user may have to provide prior authorization before the systems and methods may collect, use, store, share, or delete data associated with the user for any purpose.

Moreover, in particular embodiments, privacy policies may limit the types of data that may be collected, used, or shared by particular processes of the systems and methods for a particular purpose (as described further below). In some examples, the systems and methods may present users with an interface indicating the particular purpose for which data is being collected, used, or shared. In some examples, the privacy policies may ensure that only necessary and relevant data may be collected, used, or shared for the particular purpose, and may prevent such data from being collected, used, or shared for unauthorized purposes.

Also, in some examples, the collection, usage, storage, and sharing of any data may be subject to data minimization policies, which may limit how such data that may be collected, used, stored, or shared by the systems and methods, other entities (e.g., other users or third-party systems), or particular processes (e.g., internal research, advertising algorithms, machine-learning algorithms) for a particular purpose. In some examples, the data minimization policies may ensure that only relevant and necessary data may be accessed by such entities or processes for such purposes.

In addition, it should be appreciated that in some examples, the deletion of any data may be subject to data retention policies, which may limit the duration such data that may be user or stored by the systems and methods (or by other entities), or by particular processes (e.g., internal research, advertising algorithms, machine-learning algorithms, etc.) for a particular purpose before being automatically deleted, de-identified, or otherwise made inaccessible. In some examples, the data retention policies may ensure that data may be accessed by such entities or processes only for the duration it is relevant and necessary for such entities or processes for the particular purpose. In particular examples, privacy settings may allow users to review any of their data stored by the systems and methods or other entities (e.g., third-party systems) for any purpose, and delete such data when requested by the user.

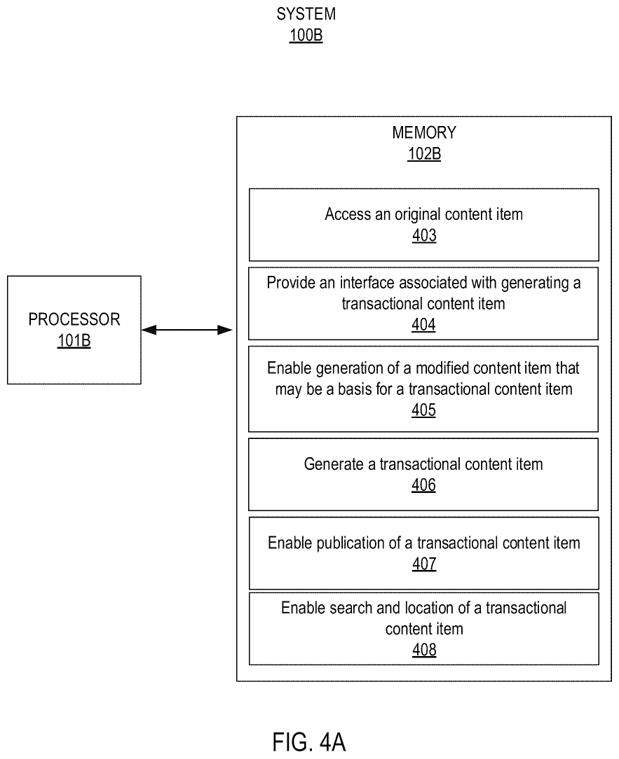

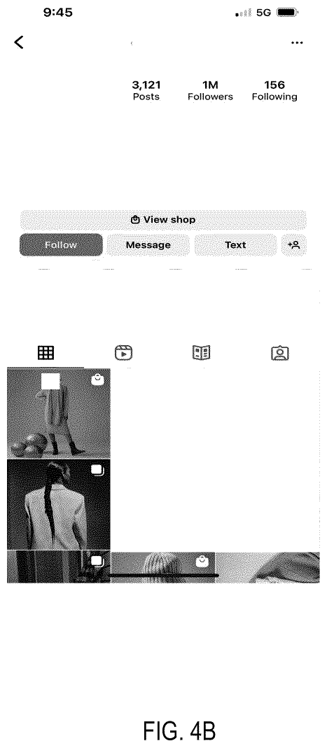

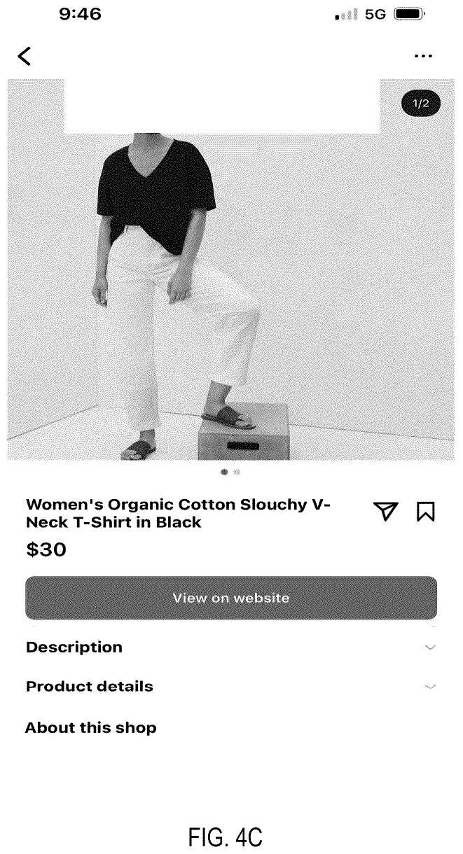

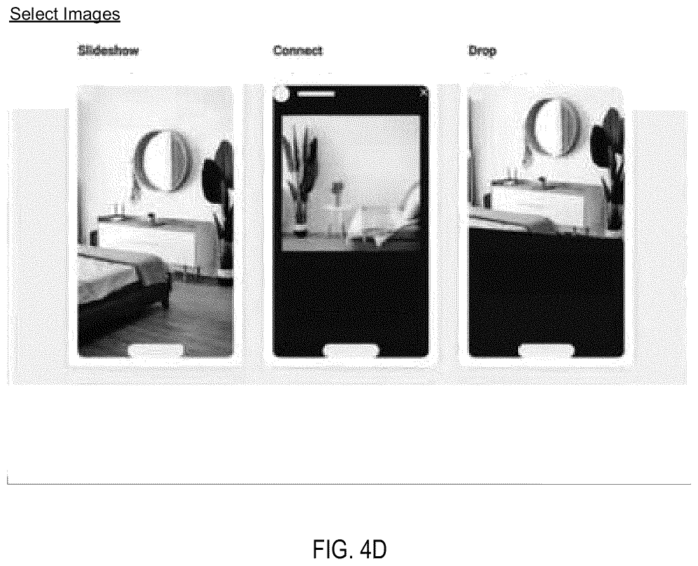

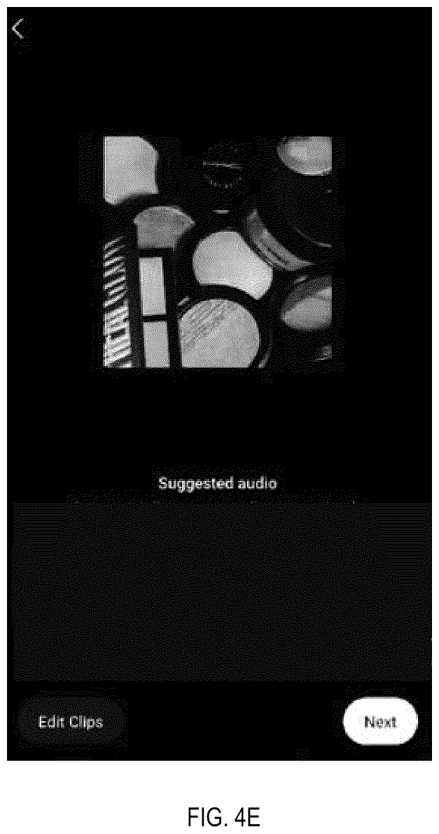

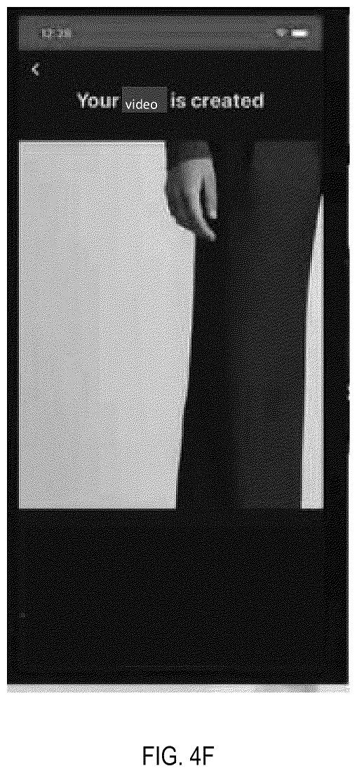

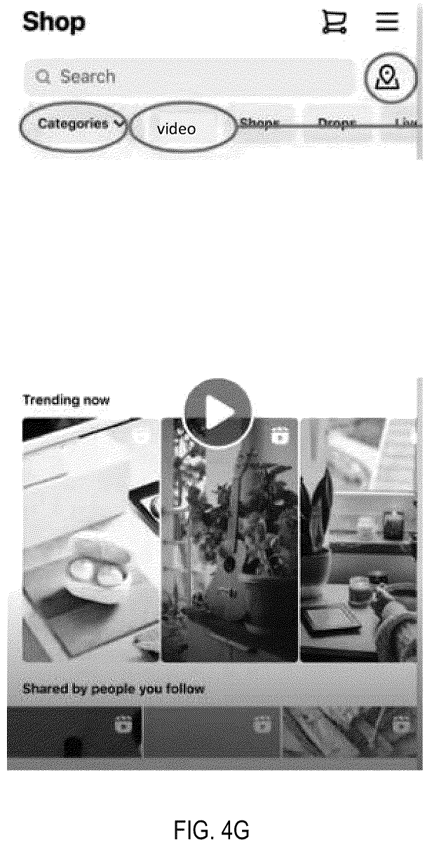

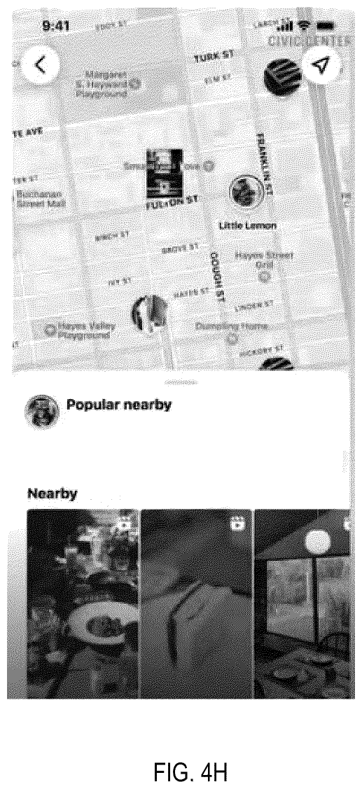

As shown in FIG. 4A, the system 100B may include processor 101B and the memory 102B. In some examples, the processor 101B may be configured to execute the machine-readable instructions stored in the memory 102B. It should be appreciated that the processor 101B may be a semiconductor-based microprocessor, a central processing unit (CPU), an application specific integrated circuit (ASIC), a field-programmable gate array (FPGA), and/or other suitable hardware device.

In some examples, the memory 102B may have stored thereon machine-readable instructions (which may also be termed computer-readable instructions) that the processor 101B may execute. The memory 102B may be an electronic, magnetic, optical, or other physical storage device that contains or stores executable instructions. The memory 102B may be, for example, random access memory (RAM), an Electrically Erasable Programmable Read-Only Memory (EEPROM), a storage device, an optical disc, or the like. The memory 102B, which may also be referred to as a computer-readable storage medium, may be a non-transitory machine-readable storage medium, where the term “non-transitory” does not encompass transitory propagating signals. It should be appreciated that the memory 102B may be provided as an example. Thus, the memory 102B may or may not include additional features, and some of the features described herein may be removed and/or modified without departing from the scope of the memory 102B outlined herein.

It should be appreciated that, and as described further below, the processing performed via the instructions on the memory 102B may or may not be performed, in part or in total, with the aid of other information and data, such as information and data provided by the external system 200 and/or the user devices 300A-300B. Moreover, and as described further below, it should be appreciated that the processing performed via the instructions on the memory 102B may or may not be performed, in part or in total, with the aid of or in addition to processing provided by other devices, including for example, the external system 200 and/or the user devices 300A-300B.

In some examples, as shown in FIG. 4A, the memory 102B may store instructions, which when executed by the processor 101B, may cause the processor to: access an original content item, provide an interface associated with generating a transactional content item, enable generation of a modified content item that may be a basis for a transactional content item, generate a transactional content item, enable publication of a transactional content item, and enable search and location of one or more transactional content items.

In some examples, and as discussed further below, the instructions 403-408 on the memory 102B may be executed alone or in combination by the processor 101B to provide generating and publishing of transactional content items based on original content items. In some examples, the instructions 403-408 may be implemented in association with a content platform configured to provide content for users, while in other examples, the instructions 403-408 may be implemented as part of a stand-alone application.

Additionally, although not depicted, it should be appreciated that to provide generating and publishing of transactional content items based on original content items, instructions 403-408 may utilize various artificial intelligence (AI) based machine learning (ML) tools. For instance, these artificial intelligence (AI) based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should also be appreciated that the system 100B may provide other types of machine learning (ML) approaches, such as reinforcement learning, feature learning, anomaly detection, etc.

In some examples, the instructions 403 may access an original content item. So, in some examples, the instructions 403 may access one or more original content items. One example of such an original content item may be one or more images associated with one or more products or services offered by a creating user. In some examples, the one or more products or services offered by a creating user may be associated with an electronic product or service catalog made available by the creating user.

In some examples, to analyze a characteristic of an original content item, the instructions 403 may determine one or more products or services associated with an original content item that may be a basis of a transactional content item. In particular, in some examples, the instructions 403 may determine one or more products or services associated with the original content item that may be suggested to be a basis of a transactional content item.

In some examples, the instructions 403 may analyze an original content item. In particular, in some examples, the instructions 403 may analyze the original content item to determine one or more characteristics or associations of the original content item. So, in one example, the association of one or more products may be based on an association as defined by a creating user that may be offering one or more products or services. In particular, in some examples, the association may be based on content items for one or more products or services that may be “tagged” by a creating user (e.g., content items as provided on an electronic product or service catalog of a creating user), or one or more products or services that otherwise may be grouped together by the user (e.g., by category, by price, by chronology etc.).

In other examples, the one or more products or services may be determined (e.g., automatically) by the instructions 403 in association with one or more machine-learning (ML) techniques that may be configured to determine, define, and/or rank a group of products or services. It may be appreciated that, as will be discussed further below, each impression of the one or more products or services may be associated with a user interface element that may be configured to facilitate an associated transaction.

In other examples, to analyze a characteristic of an original content item, the instructions 403 may determine a subject matter associated with the original content item. In still other examples, the instructions 403 may analyze the original content item to determine one or more entities (e.g., a person, a corporation, etc.) associated with the original content item. So, in some examples, the original content item may be associated with a content creator and/or seller associated with a product or service that the original content item may be related to. In some instances, this may be referred to as “seller generated content” (or “SGC”). Examples may include images and video that may be provided (e.g., uploaded, tagged, liked, etc.) by the content creator and/or seller. In other examples, the original content item may be associated with a user (e.g., a social application influencer, a celebrity, etc.) associated with a product or service that the original content item may be related to. Examples may include images and video that may be provided by a third-party user that may be related to (e.g., may have interacted with) the product or service, or even the content creator and/or seller, and may have provided (e.g., uploaded, tagged, liked, etc.) the original content item. In some instances, this may be referred to as “user generated content” (or “UGC”).

In some examples, the instructions 404 may provide an interface associated with generating a transactional content item. In particular, in some examples, the instructions 404 may provide one or more interface elements that may enable a creating user to utilize an original content item (e.g., as accessed via the instructions 403) to generate the transactional content item.

In some examples and as will be discussed further below, one or more interface elements (e.g., a selectable button) may be associated with a digital storefront of a creating user. FIG. 4B illustrates one or more interface elements associated with a digital storefront, according to an example. It may be appreciated that the one or more interface elements that may enable generation of a transactional content item may be associated with any number of other aspects (e.g., an advertising application or feature) of a creating user on a content platform.

In order to generate a transactional content item, in some examples, the instructions 404 may determine one or more products or services associated with an original content item that may be a basis of a transactional content item (e.g., from a collection of products or services associated with a social application “page” of a creating user). FIG. 4C illustrates one or more interface elements associated with a product page, according to an example.

In some examples, the instructions 404 may receive input (e.g., from a creating user) that one or more products or services may be the basis for the transactional content item. In other examples, the instructions 404 may determine (e.g., automatically) one or more products or services associated with the original content item that may be utilized or suggested (e.g., to a creating user) to be a basis of a transactional content item.

So, in one example where a company may have listed one or more images and text descriptions related to three of its products, the instructions 404 may analyze the one or more images and text descriptions to determine that the three products may be a basis for one or more transactional content items. It may be appreciated that in order to determine one or more products or services associated with an original content item that may be a basis of a transactional content item (e.g., automatically), the instructions 404 may be configured to implement one or more aspects of neural networking, artificial intelligence (AI), and machine learning (ML) techniques.

In particular, with regard to the interface elements related to generating a modified content item that may be used to generate a transactional content item, the instructions 404 (as will be discussed further below) may enable a creating user (e.g., via a selectable user interface element) to generate a short-form video (e.g., of a duration of ten minutes or less) that may be a basis for a transaction content item. In some examples, the one or more interface elements may be included a “dashboard” directed to enabling the creating user to generate the transactional content item.

In some examples, the instructions 405 may enable generation (e.g., by a creating user) of a modified content item that may be a basis for a transactional content item. Examples of some of the one or more interface elements on the dashboard as provided via the instructions 404 may relate to editing (e.g., trimming, clipping, arranging, etc.) of an original content item (e.g., an audio content item, a video content item), addition or removal of content items (e.g., images or video that may be associated with a product or service), and generating a clip (e.g., an audio clip, a video clip) from an original content item. FIG. 4D illustrates one or more interface elements associated with selection of an image, according to an example.

In some examples, to enable generation of a modified content item that may be a basis for a transactional content item, the instructions 405 may be configured to provide and/or implement one or more templates. In particular, the one or more templates may relate any aspect of generation of the transactional content item, and may be implemented to, for example, enhance appeal or engagement associated with the transactional content item. Indeed, in some examples, the instructions 405 may provide one or more templates via a “Create a Video” button that may be selected by a creating user to generate a modified content item that may be a basis for an associated transactional content item.

In some examples, the instructions 405 may implement a template that may arrange (e.g., via a tiling format) or may enable a creating user to arrange one or more content items to be provided in a transactional content items (e.g., a plurality of images associated with various products or services). In another example, the instructions 405 may implement a template that may associate (or “sync”) an audio content item with one or more content items (e.g., a plurality of images associated with various products or services). FIG. 4E illustrates one or more interface elements associated with addition of audio to a content item, according to an example.

In some examples, a template implemented by the instructions 405 may enable a creating user to utilize a “highlight moment” of an original content item (e.g., as provided via the instructions 403) to generate a modified content item that may then be utilized to generate a transactional content item. So, in an example where an original content item may relate to a short-form video related to a product from a social application influencer, the modified content item may relate to a particular portion of the original content item where the social application influencer may be presenting a particular item of clothing. Indeed, it may be appreciated that the template implemented via the instructions 405 may relate to any and all aspects of generating a transaction content item associated with a product or service.

Also, in particular, with regard to enabling a creating user to extract a particular portion of an original content item to generate the modified content item, the instructions 405 may provide one or more user interface elements that may be used (e.g., by a user) to modify (e.g., edit, trim, cut, etc.) one or more portions of an original content item to generate the modified content item. In some examples, the user interface elements may take the form of adjustable “bars” that may be associated with timespans of the original content item.

In addition, in some examples, the instructions 405 may provide one or more interface elements that may enable (e.g., by a creating user) addition of various media (e.g., audio, text). For example, in some instances, the instructions 405 may be configured to, via implementation of various machine-learning (ML) techniques, associate (or “sync”) audio content with image or video content (e.g., associated with products or services offered by a creating user). Also, in some examples, the instructions 405 may enable (e.g., by a creating user) addition of content items (e.g., created by the creating user and/or by other users) as well.

In some examples and as will be discussed further below, enabling a creating user to generate the modified content item via the instructions 405 may include, among other things, providing one or more interface elements that may relate to providing a preview (e.g., audio or video preview) of the modified content item to be generated. In these examples, the instructions 405 may enable a viewing of each of the modified content items.

In addition, in some examples, the instructions 405 may be configured to provide suggestions of particular portions of an original content item that may be used to generate the modified content item. Also, in some examples, the instructions 405 may enable a creating user to extract a particular portion of an original content item to generate the modified content item. In particular, with regard to providing suggestions of a particular portions of an original content item that may be used to generate the modified content item, the instructions 405 may provide one or more user interface elements that may be used to demarcate suggested portions of the original content that may be used to generate the modified content item. In some examples, the user interface elements that may be used to demarcate may take the form of adjustable “bars” that may correspond to timespans in the associated original content item.

In some examples, to generate a modified content item, the instructions 405 may generate and/or provide a supplemental content item associated with an original content item. In particular, in some examples, the instructions 405 may combine a supplemental content item provided via the instructions 405 with an original content item to generate a transactional content item. So, in one example, where the original content item may be a plurality of images associated with a product line offered by a creating user and the supplemental content item may be a plurality of product descriptions (e.g., text) associated with the product line (also known as “product description pages” or “PDPs”), the transactional content item may be a short-form video including the plurality of images and the plurality of product descriptions. It may be appreciated that, in some examples, a supplemental content item determined via the instructions 405 may take any form of a content item, and in some examples, may be included (e.g., embedded) in the associated transactional content item.

In some examples, a supplemental content item provided via the instructions 405 may enable an action to be taken (e.g., by a viewing user). So, for example, in some examples, the supplemental content item may be a selectable button that, when selected by a viewing user, may enable access a new interface or interface element (e.g., an informational website related to a product in an original content item, a product checkout or shopping cart, etc.). It may be appreciated that the new interface or interface element, in some examples, may enable a viewing user to conduct a related transaction (e.g., a purchase).

In some examples, the instructions 406 may generate a transactional content item. In some examples, the transactional content item generated via the instructions 406 may be based on a modified content item (e.g., as specified by a creating user via the instructions 405). In other examples, it may be appreciated that the instructions 406 may automatically generate the transactional content item in conjunction with one or more neural networking, artificial intelligence (AI), and machine learning (ML) techniques.

In particular, in some examples, upon receiving information associated with the instructions 403-405 (e.g., user input regarding timespans of an original content item to be used), the instructions 406 may utilize this information to generate a transactional content item. In some examples, the transactional content item generated via the instructions 406 may be a short-form video (e.g., a short-form video related to a product or service) based on an original content item (e.g., an image related to the same product or service). So, in one example, the instructions 406 may provide an original content item (e.g., an image) and a transactional content item located on a user interface associated with an electronic product or service catalog of a creating user.

In some examples, upon generation of a transactional content item, the instructions 406 may provide a notification (e.g., to an associated user) to inform of the generation of the transactional content item (e.g., “Your video is created.”). FIG. 4F illustrates one or more interface elements associated with indicating generation of a content item, according to an example. In addition, in some examples, the notification provided via the instructions 406 may be provided along with a preview of the transactional content item.

In some examples, a transactional content item generated via the instructions 406 may include various information associated with one or more transactions. That is, in some examples, the transactional content item generated via the instructions 406 may include information that may be directed to facilitating the one or more transactions.

So, in some examples, the instructions 406 may generate a transactional content item to include one or more interface elements directed to facilitating one or more transactions. In some examples, the one or more interface elements may include a selectable button featuring an item (e.g., a product, a service, etc.) that may be transacted for. In one example where the transactional content item may relate to a dress worn by a social application influencer, the instructions 406 may include a first interface element (e.g., a selectable button) to provide information (e.g., a product details “page” including images, price, user reviews, variations, etc.) about the dress to a receiving user. In addition, the transactional content item may include a second interface element (e.g., a selectable button) to enable the receiving user to initiate a purchase of the dress (e.g., a quantity of items to be purchased). In some examples, upon selection of the second interface element by a receiving user, the instructions 406 may provide a payment transaction (or “checkout”) interface (e.g., including payment method specification, shipping information, etc.) that may enable the receiving user to product the dress.

In addition, in some examples, the instructions 406 may provide other types of interface elements in a transactional content item as well. For example, in some instances, where the transactional content item may be associated with a first product or service, the instructions 406 may provide another interface element (e.g., a floating, rectangular viewing box) that may provide a receiving user an opportunity to view one or more other transactional content items (e.g., presented via a “feed” of content items), which may relate to the first product or service or to other products and services.

In some examples, the instructions 407 may enable publication of a transactional content item. It may be appreciated that the instructions 407 may distribute the transactional content item to one or more content platforms, such as a social media platform or a content sharing platform. In particular, in some examples, the instructions 407 may enable publication of the transactional content item on or in any number of settings associated with the one or more content platforms. So, in one example, the instructions 407 may enable the transactional content item to be published on a digital “storefront” associated with the creating user, wherein a selection of a button provided via the instructions 407 may enable playback of the transactional content item or purchase of a related product or service. In another example, the instructions 407 may provide an interface element that may enable users to search and select (e.g., for playback) the transactional content item. In yet another example, the instructions 407 may provide the transactional content item as an advertisement item (e.g., a banner ad) that may be selected for playback.

It may be appreciated that, upon generation of a transactional content item (e.g., via the instructions 403-406), the instructions 407 may enable “organic” distribution of the transactional content item on one or more content platforms. That is, in some examples, the instructions 407 may be configured to distribute the transactional content item to one or more destination devices and associated users (e.g., of a social application) via one or more distribution algorithms. So, for example, in some instances, a distribution algorithm may utilize preferences, content (e.g., subject matter), and/or “virality” to distribute transactional content item to one or more users that may be likely to consume the transactional content item. However, it may also be appreciated that, in addition to “organic” distribution of a transactional content item, the instructions 407 may enable “directed” distribution of the transactional content item on one or more content platforms.

In some examples, the instructions 408 may enable search and location of one or more transactional content items. In particular, in some examples, the instructions 408 may enable a user (e.g., a viewing user) to find a transactional content item that may be associated with a particular product or service. FIG. 4G illustrates one or more interface elements associated with providing search of transactional content items, according to an example.

Moreover, in some examples, the instructions 408 may enable the user to implement a search according to various criteria, including but not limited to product or service type, product or service category, location (e.g., products or services that are located near to a viewing user), and feedback (e.g., ratings) associated with relevant parties to a transaction (e.g., feedback associated with a seller). FIG. 4H illustrates one or more interface elements associated with providing transactional content items based on location, according to an example. In addition, in some examples where a search may return more than one result, the instructions 408 may be configured to “rank” the returned result according to one or more of the various criteria as well.

In some examples, to enable a viewing user to receive a transactional content item that may be of interest, the instructions 408 may utilize a “social graph” associated with the viewing user. In particular, in some examples, the instructions 408 may enable a viewing user to receive transactional content items associated with products or services that may be “tagged” by other users that may be associated with the viewing user. As a result, in some examples, based on the inherently increased trust provided from those associated with the viewing user, the viewing user may be more likely to conduct an associated transaction.

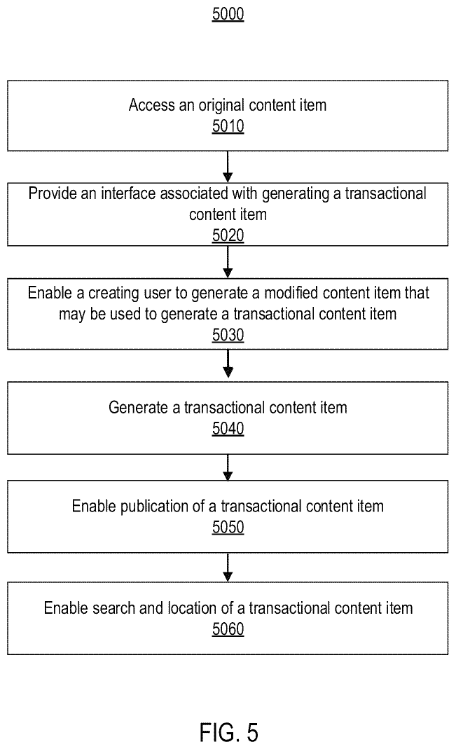

FIG. 5 illustrates a method for generate and publish transactional content items based on original content items, according to an example. The method 5000 is provided by way of example, as there may be a variety of ways to carry out the method described herein. Each block shown in FIG. 5 may further represent one or more processes, methods, or subroutines, and one or more of the blocks may include machine-readable instructions stored on a non-transitory computer-readable medium and executed by a processor or other type of processing circuit to perform one or more operations described herein.

Although the method 5000 is primarily described as being performed by system 100B as shown in FIG. 4A, the method 5000 may be executed or otherwise performed by other systems, or a combination of systems. It should be appreciated that, in some examples, to provide generating and publishing of transactional content items based on original content items, the method 5000 may be configured to incorporate artificial intelligence (AI) or deep learning techniques, as described above. It should also be appreciated that, in some examples, the method 5000 may be implemented in conjunction with a content platform (e.g., a social media platform) to generate and deliver content.

Reference is now made with respect to FIG. 5. At 5010, in some examples, the processor 101B may access an original content item. In some examples, to analyze a characteristic of an original content item, the processor 101B may determine one or more products or services associated with an original content item that may be a basis of a transactional content item. In some examples, the processor 101B may analyze an original content item. In other examples, to analyze a characteristic of an original content item, the processor 101B may determine a subject matter associated with the original content item. In still other examples, the processor 101B may analyze the original content item to determine one or more entities (e.g., a person, a corporation, etc.) associated with the original content item. In some examples, the processor 101B may provide an interface associated with generating a transactional content item. In order to generate a transactional content item, in some examples, the processor 101B may determine one or more products or services associated with an original content item that may be a basis of a transactional content item (e.g., from a collection of products or services associated with a social application “page” of a creating user). In some examples, the processor 101B may receive input (e.g., from a creating user) that one or more products or services may be the basis for the transactional content item. In other examples, the processor 101B may determine (e.g., automatically) one or more products or services associated with the original content item that may be utilized or suggested (e.g., to a creating user) to be a basis of a transactional content item.

At 5020, in some examples, the processor 101B may enable generation (e.g., by a creating user) of a modified content item that may be a basis for a transactional content item. In some examples, to enable generation of a modified content item that may be a basis for a transactional content item, the processor 101B may be configured to provide and/or implement one or more templates. Also, in particular, with regard to enabling a creating user to extract a particular portion of an original content item to generate the modified content item, the processor 101B may provide one or more user interface elements that may be used (e.g., by a user) to modify (e.g., edit, trim, cut, etc.) one or more portions of an original content item to generate the modified content item. In some examples, the user interface elements may take the form of adjustable “bars” that may be associated with timespans of the original content item. In addition, in some examples, the processor 101B may provide one or more interface elements that may enable (e.g., by a creating user) addition of various media (e.g., audio, text).

At 5030, in some examples, to generate a modified content item, the processor 101B may generate and/or provide a supplemental content item associated with an original content item. In particular, in some examples, the processor 101B may combine a supplemental content item provided via the processor 101B with an original content item to generate a transactional content item. In some examples, a supplemental content item provided via the processor 101B may enable an action to be taken (e.g., by a viewing user).

At 5040, in some examples, the processor 101B may generate a transactional content item. In some examples, the transactional content item generated via the processor 101B may be based on a modified content item (e.g., as specified by a creating user via the processor 101B). In other examples, it may be appreciated that the processor 101B may automatically generate the transactional content item in conjunction with one or more neural networking, artificial intelligence (AI), and machine learning (ML) techniques.

In some examples, upon generation of a transactional content item, the processor 101B may provide a notification (e.g., to an associated user) to inform of the generation of the transactional content item (e.g., “Your video is ready to view.”). In some examples, a transactional content item generated via the processor 101B may include various information associated with one or more transactions. In addition, in some examples, the processor 101B may provide other types of interface elements in a transactional content item as well.

At 5050, in some examples, the processor 101B may enable publication of a transactional content item. It may be appreciated that the processor 101B may distribute the transactional content item to one or more content platforms, such as a social media platform or a content sharing platform. In particular, in some examples, the processor 101B may enable publication of the transactional content item on or in any number of settings associated with the one or more content platforms.

At 5060, in some examples, the processor 101B may enable search and location of one or more transactional content items. In particular, in some examples, the processor 101B may enable a user (e.g., a viewing user) to find a transactional content item that may be associated with a particular product or service. Moreover, in some examples, the processor 101B may enable the user to implement a search according to various criteria, including but not limited to product or service type, product or service category, location (e.g., products or services that are located near to a viewing user), and feedback (e.g., ratings) associated with relevant parties to a transaction (e.g., feedback associated with a seller). In addition, in some examples where a search may return more than one result, the processor 101B may be configured to “rank” the returned result according to one or more of the various criteria as well. In some examples, the processor 101B may enable a viewing user to receive transactional content items associated with products or services that may be “tagged” by other users that may be associated with the viewing user.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

With the proliferation of different types of digital content delivery mechanisms (e.g., mobile phone, portable computing devices, tablet devices, etc.), it has become crucial that content providers, such as vendors looking to advertise a good or service, engage users with content of interest. As a result, content providers are continuously looking for ways to deliver more appealing content.

In some instances, short-form video may be an appealing option due to its immediate, inexpensive, and versatile nature. As used herein, “short-form video” may include any video content that may span a time of a few of seconds to ten minutes.

For example, small businesses with limited budgets may find short-form video appealing because it may offer an opportunity to reach potential customers in a very convenient manner. So, in one example, a vendor may generate an advertising content item via short-form video to engage potential customers, and may distribute the short-form video over a content platform (e.g., a social media platform) to make users aware of their product.

However, short-form video may also come with its own drawbacks. Specifically, in many instances, short-form video may be difficult to monetize. For example, monetization of short-form video may sometimes require significant amounts of “post-processing” (e.g., editing, addition of visual or audio effects, formatting, etc.). However, in many instances, content creators may not have skills required to generate professional-quality content. Moreover, enlisting help from those with the required skills may be costly and time-consuming as well.

Systems and methods described may provide for generating and publishing transactional content items based on original content items. As used herein, an “original content item” may include any content item (e.g., audio content item, video content item) that may be used to generate another content item. As used herein, a “transactional content item” may include any content item that may be based on an original content item, and may be associated with transaction that may be conducted.

In some examples, the systems and methods may enable a creating user to input specifications for a short-form video that may be used to enable a transaction with one or more receiving users. As used herein, a “creating user” may include any user that may generate content item (e.g., a short-form video). An example of a creating user may be a vendor seeking to generate content items to sell a product or service. Also, as used herein, a “receiving user” may include any user that may utilize may view a content item (e.g., a short-form video) that may be published by a creating user. An example of a receiving user may be a user of a social application that may be viewing content items (e.g., short-form videos) via a “feed” on a social application.

In some examples, to generate a transactional content item, the systems and methods may provide an interface associated with generation of the transactional content item. As will be discussed in further detail below, in some examples, the systems and methods may provide one or more interface elements that may enable a creating user to utilize an original content item to generate the transactional content item. Examples of interface elements may be those associated with viewing a content item, editing of an original content item, generating a clip from an original content item, and generating a modified content item that may be used to generate a transactional content item. In some examples, the interface elements may be provided on a “dashboard” directed to, among other things, generating a transactional content item.

In some examples, to generate a transactional content item, the systems and methods may determine one or more products or services associated with an original content item that may be a basis of the transactional content item. It may be appreciated that in order to determine one or more products or services associated with an original content item that may be a basis of a transactional content item (e.g., automatically), the systems and methods may implement one or more aspects of neural networking, artificial intelligence (AI), and machine learning (ML).

In some examples, to generate a transactional content item, the systems and methods may enable a creating user to generate a modified content item. As used herein, a “modified content item” may be a content item that may be a modified version (e.g., modified by a creating user) of an original content item. So, in one example, where an original content item may be a long-form livestream video of a product launch, a modified content item may be a thirty (30) second clip clipped by a creating user to be a basis for a transactional content item. In some examples, the modified content item may be used to generate the transactional content item by adding transactional information and interface elements to the modified content item.

It may be appreciated that, in some examples, to enable a creating user to generate a modified content item, the systems and methods may provide suggestions of a particular portions of an original content item that may be used to generate the modified content item. In particular, in some examples, the systems and methods may provide one or more user interface elements that may be used to demarcate suggested portions of the original content that may be used to generate the modified content item.

In some examples and as will be discussed further below, the systems and methods may generate a transactional content item based on a modified content item. In some examples, the transactional content item generated may be a short-form video based on a modified content item. In some examples, the systems and methods may generate a transactional content item to include one or more interface elements directed to facilitating one or more transactions. Also, in some examples, the systems and methods may automatically generate the transactional content item in conjunction with one or more neural networking, artificial intelligence (AI), and machine learning (ML) techniques.

The systems and methods described herein may be implemented in various contexts. So, in some examples, a commercial entity (e.g., a large corporation managing a well-known “brand” of products and services) may utilize the systems and methods described herein to generate and distribute content items efficiently and inexpensively. For example, in some instances, a commercial entity may publish a long-form livestream of a launch of multiple products and services. In these instances, the systems and methods may enable the commercial entity to generate one or more transactional content items (e.g., short-form videos), each associated with the multiple products and services, wherein the one or more transactional content items may enable receiving users to conduct related transactions. Furthermore, in some examples, by providing simple user interface elements in the one or more transactional content items, the systems and methods may facilitate related transactions efficiently.

As such, in some instances, the commercial entity may reach new customers that otherwise may not have been reached. More specifically, for example, while the long-form livestream may have reached a predetermined group of viewers (e.g., followers of an associated social application account), the transactional content item may have reached others outside of the predetermined group of viewers. Accordingly, in some examples, the systems and methods may enable customers with lesser direct intent to conduct transaction for products and services that were previously unknown to them.

In addition, the systems and methods may benefit content creators as well. Specifically, by providing simple user interface elements that may enable content creators to efficiently create content items that may easily consumable by viewers. Furthermore, it may be appreciated that the systems and methods described may enable content creators to more readily monetize their content, in that the systems and methods may “narrow the gap” between content creation and content monetization. In some examples, the systems and methods may automate processes associated with monetization, such as determining which products or services to features and which portions of content items to utilize, and therefore may make it significantly easier for content creators to benefit from their creations. It should be appreciated that while the examples described herein may relate primarily to advertising and content generation in advertising, the systems and methods described may have numerous other applications as well.

In some examples, the information associated with generation and publication of transaction content items may be gathered and utilized according to various policies. For example, in particular embodiments, privacy settings may allow users to review and control, via opt in or opt out selections, as appropriate, how their data may be collected, used, stored, shared, or deleted by the systems and methods or by other entities (e.g., other users or third-party systems), and for a particular purpose. The systems and methods may present users with an interface indicating what data is being collected, used, stored, or shared by the systems and methods described (or other entities), and for what purpose. Furthermore, the systems and methods may present users with an interface indicating how such data may be collected, used, stored, or shared by particular processes of the systems and methods or other processes (e.g., internal research, advertising algorithms, machine-learning algorithms). In some examples, a user may have to provide prior authorization before the systems and methods may collect, use, store, share, or delete data associated with the user for any purpose.

Moreover, in particular embodiments, privacy policies may limit the types of data that may be collected, used, or shared by particular processes of the systems and methods for a particular purpose (as described further below). In some examples, the systems and methods may present users with an interface indicating the particular purpose for which data is being collected, used, or shared. In some examples, the privacy policies may ensure that only necessary and relevant data may be collected, used, or shared for the particular purpose, and may prevent such data from being collected, used, or shared for unauthorized purposes.

Also, in some examples, the collection, usage, storage, and sharing of any data may be subject to data minimization policies, which may limit how such data that may be collected, used, stored, or shared by the systems and methods, other entities (e.g., other users or third-party systems), or particular processes (e.g., internal research, advertising algorithms, machine-learning algorithms) for a particular purpose. In some examples, the data minimization policies may ensure that only relevant and necessary data may be accessed by such entities or processes for such purposes.

In addition, it should be appreciated that in some examples, the deletion of any data may be subject to data retention policies, which may limit the duration such data that may be user or stored by the systems and methods (or by other entities), or by particular processes (e.g., internal research, advertising algorithms, machine-learning algorithms) for a particular purpose before being automatically deleted, de-identified, or otherwise made inaccessible. In some examples, the data retention policies may ensure that data may be accessed by such entities or processes only for the duration it is relevant and necessary for such entities or processes for the particular purpose. In particular examples, privacy settings may allow users to review any of their data stored by the systems and methods or other entities (e.g., third-party systems) for any purpose, and delete such data when requested by the user.

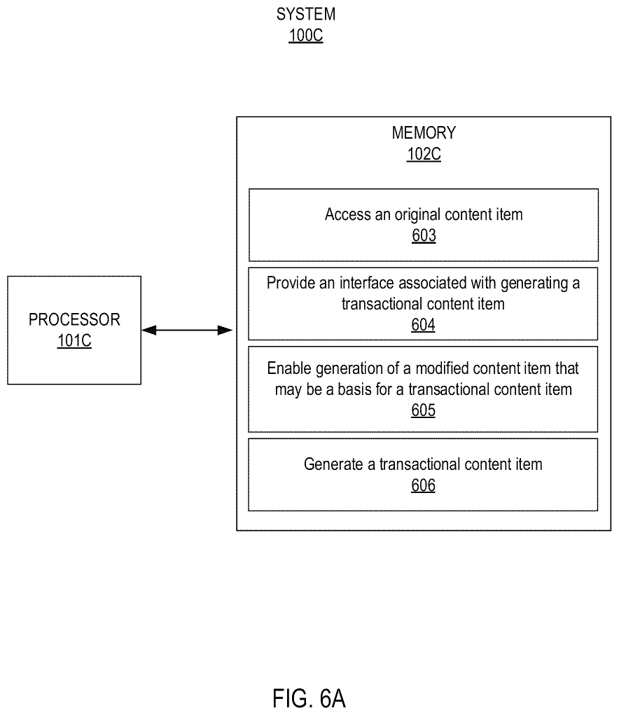

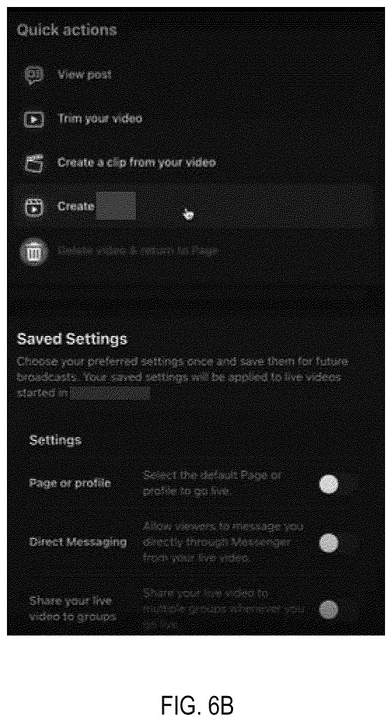

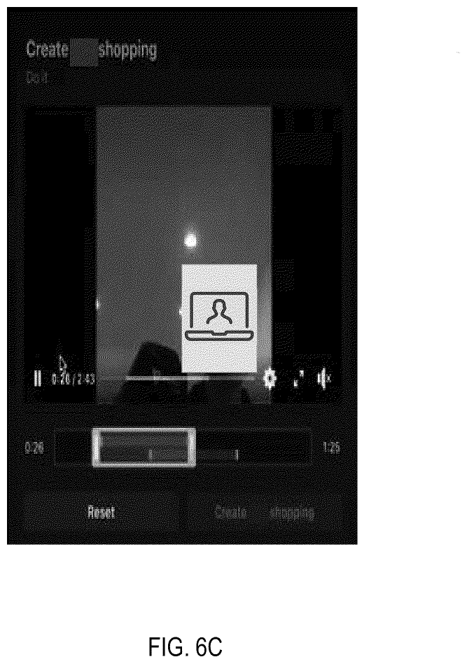

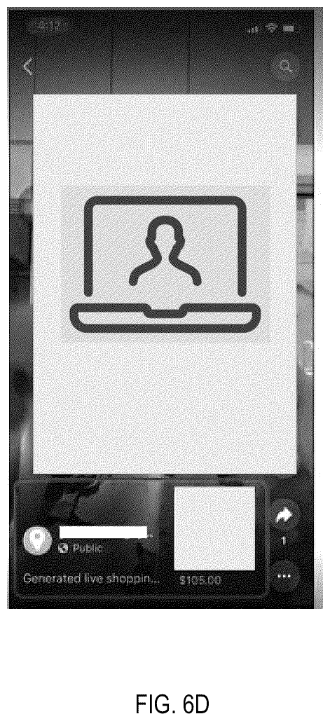

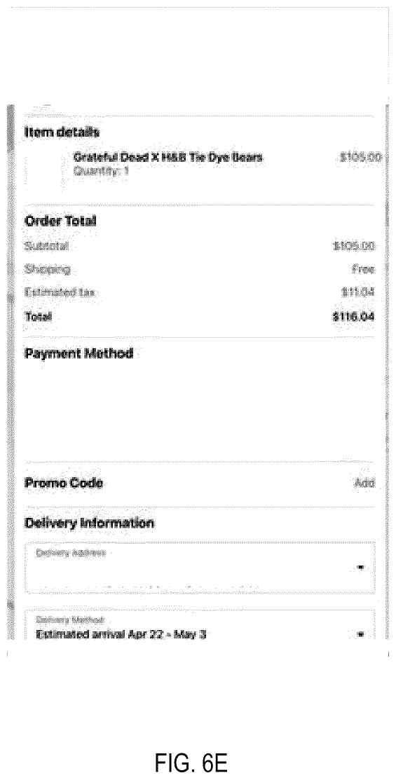

As shown in FIG. 6A, the system 100C may include processor 101C and the memory 102C. In some examples, the processor 101C may be configured to execute the machine-readable instructions stored in the memory 102C. It should be appreciated that the processor 101C may be a semiconductor-based microprocessor, a central processing unit (CPU), an application specific integrated circuit (ASIC), a field-programmable gate array (FPGA), and/or other suitable hardware device.

In some examples, the memory 102C may have stored thereon machine-readable instructions (which may also be termed computer-readable instructions) that the processor 101C may execute. The memory 102C may be an electronic, magnetic, optical, or other physical storage device that contains or stores executable instructions. The memory 102C may be, for example, random access memory (RAM), an Electrically Erasable Programmable Read-Only Memory (EEPROM), a storage device, an optical disc, or the like. The memory 102C, which may also be referred to as a computer-readable storage medium, may be a non-transitory machine-readable storage medium, where the term “non-transitory” does not encompass transitory propagating signals. It should be appreciated that the memory 102C may be provided as an example. Thus, the memory 102C may or may not include additional features, and some of the features described herein may be removed and/or modified without departing from the scope of the memory 102C outlined herein.

It should be appreciated that, and as described further below, the processing performed via the instructions on the memory 102C may or may not be performed, in part or in total, with the aid of other information and data, such as information and data provided by the external system 200 and/or the user devices 300A-300B. Moreover, and as described further below, it should be appreciated that the processing performed via the instructions on the memory 102C may or may not be performed, in part or in total, with the aid of or in addition to processing provided by other devices, including for example, the external system 200 and/or the user devices 300A-300B.

In some examples, the memory 102C may store instructions, which when executed by the processor 101C, may cause the processor to: access an original content item; provide an interface associated with generating a transactional content item; enable a creating user to generate a modified content item that may be used to generate a transactional content item; and generate a transactional content item.

In some examples, as shown in FIG. 6A and as discussed further below, the instructions 603-606 on the memory 102C may be executed alone or in combination by the processor 101C to provide generating and publishing of transactional content items based on original content items. In some examples, the instructions 603-606 may be implemented in association with a content platform configured to provide content for users, while in other examples, the instructions 603-606 may be implemented as part of a stand-alone application.

Additionally, although not depicted, it should be appreciated that to provide generating and publishing of transactional content items based on original content items, instructions 603-606 may utilize various artificial intelligence (AI) based machine learning (ML) tools. For instance, these artificial intelligence (AI) based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should also be appreciated that the systems 100A-100C may provide other types of machine learning (ML) approaches, such as reinforcement learning, feature learning, anomaly detection, etc.

In some examples, the instructions 603 may access an original content item. So, in some examples, the instructions 603 may access a long-form video (e.g., a video content item that may be one hour in length) in order to generate a transaction content item associated with one or more products or services. One example of such a long-form video may be a shopping livestream (video) from a social application influencer. Another example of such a long-form video may be an informational video produced by a company (e.g., a brand) that may relate to one or more of the company's products.

In some examples, the instructions 604 may provide an interface associated with generating a transactional content item. In particular, in some examples, the instructions 604 may provide one or more interface elements that may enable a creating user to utilize an original content item (e.g., as accessed via the instructions 603) to generate the transactional content item.

In order to generate a transactional content item, in some examples, the instructions 604 may determine one or more products or services associated with an original content item that may be a basis of a transactional content item. In particular, in some examples, the instructions 604 may determine one or more products or services associated with the original content item that may be suggested (e.g., to a creating user) to be a basis of a transactional content item.

So, in one example where a company may have created a long-form content item related to three of its products, the instructions 604 may analyze the long-form content item to determine that the three products may be a basis for one or more transactional content items. It may be appreciated that in order to determine one or more products or services associated with an original content item that may be a basis of a transactional content item (e.g., automatically), the instructions 604 may be configured to implement one or more aspects of neural networking, artificial intelligence (AI), and machine learning (ML).

In some examples, the one or more interface elements may be included a “dashboard” directed to enabling the creating user to generate the transactional content item. Examples of some of the one or more interface elements on the dashboard as provided via the instructions 604 may relate to viewing a content item, editing (e.g., trimming, clipping, etc.) of an original content item (e.g., an audio content item, a video content item), generating a clip (e.g., an audio clip, a video clip) from an original content item, and generating a modified content item (e.g., “Create a Video”) that may be used to generate a transactional content item. In particular, with regard to the interface elements related to generating a modified content item that may be used to generate a transactional content item, the instructions 604 (as will be discussed further below) may invite a creating user (e.g., via a selectable user interface element) to generate a short-form video (e.g., of a duration of ten minutes or less) that may be a basis for a transaction content item.

FIG. 6B illustrates a user interface providing generation and publishing of transactional content items based on original content items, according to an example. Specifically, FIG. 6B illustrates one or more interface elements (e.g., selectable buttons) associated with a dashboard for generating a transactional content item.

In some examples, the instructions 605 may enable generation (e.g., by a creating user) of a modified content item that may be a basis for a transactional content item. So, in some examples, the instructions 605 may enable a creating user to utilize a “highlight moment” of a video (e.g., an original content item provided via the instructions 603) to generate a modified content item that may then be utilized to generate a transactional content item. So, in an example where an original (e.g., long-form video) content item may relate to a shopping livestream (video) from a social application influencer, the modified content item may relate to a particular portion of the original content item where the influencer may be presenting a particular item of clothing.

In some examples and as will be discussed further below, enabling a creating user to generate the modified content item via the instructions 605 may include, among other things, providing one or more interface elements that may relate to providing a preview (e.g., audio or video preview) of the modified content item to be generated, providing suggestions of particular portions of an original content item that may be used to generate the modified content item, and enabling a creating user to extract a particular portion of an original content item to generate the modified content item.

In particular, with regard to providing suggestions of a particular portions of an original content item that may be used to generate the modified content item, the instructions 605 may provide one or more user interface elements that may be used to demarcate suggested portions of the original content that may be used to generate the modified content item. In some examples, the user interface elements that may be used to demarcate may take the form of adjustable “bars” that may correspond to timespans in the associated original content item.

FIG. 6C illustrates a user interface providing generation and publishing of transactional content items based on original content items, according to an example. Specifically, FIG. 6C illustrates one or more interface elements (e.g., adjustable bars) associated with a transactional content item.

In some examples, the instructions 605 may utilize various methods to determine suggested portions of an original content item that may be used to generate a modified content item. So, in a first example, the instructions 605 may determine that a portion of a content item may be associated with a particular transactional characteristic. One example of such a transactional characteristic may be an exclusive or featured offer (or “deal”), wherein a seller may indicate that a particular product or service may be a basis of an exclusive or featured offer. For example, in some examples, the instructions 605 may provide a user interface element that may indicate any products or services that may be featured in an original content item, and may enable a creating user to select one or more of the products or services to be a basis of a modified content item (e.g., by providing a start time in the original content item where the featured product or service is shown). In such a case, the instructions 605 may determine that a particular portion of an original content item associated with a product or service related to the exclusive offer may be suggested.

Another example of such a transactional characteristic may be an offer that may be discounted from an original offer. So, in such an example, an offer that may be fifty (50) percent (%) off of an original offer for a product or service may be provided as a suggestion. In some examples, the instructions 605 may provide a user interface element that may indicate any products or services that may be discounted from an original offer, and may enable a creating user to select one or more of discounted products or services to be a basis of a modified content item (e.g., by providing a start time in the original content item where the discounted product or service is shown). It may be appreciated that in order to determine suggested portions of an original content item that may be used to generate a modified content item, the instructions 605 may be configured to implement one or more aspects of neural networking, artificial intelligence (AI), and machine learning (ML).

Also, in particular, with regard to enabling a creating user to extract a particular portion of an original content item to generate the modified content item, the instructions 605 may provide one or more user interface elements that may be used (e.g., by a user) to modify (e.g., edit, trim, cut, etc.) one or more portions of an original content item to generate the modified content item. In some examples, the user interface elements may take the form of adjustable “bars” that may be associated with timespans of the original content item. So, in some examples, the instructions 605 may enable a creating user to generate a modified content item (e.g., via use of one or more adjustable bars) that may be associated with one or more products or services in an original content item. In some examples, upon enabling the adjustment of the user interface elements, the instructions 605 may generate the modified content item (e.g., a short-form video).

In some examples, the instructions 606 may generate a transactional content item. In some examples, the transactional content item generated via the instructions 606 may be based on a modified content item (e.g., as specified by a creating user via the instructions 605). In other examples, it may be appreciated that the instructions 606 may automatically generate the transactional content item in conjunction with one or more neural networking, artificial intelligence (AI), and machine learning (ML) techniques.

In particular, in some examples, upon receiving information associated with the instructions 603-605 (e.g., user input regarding timespans of an original content item to be used), the instructions 606 may utilize this information to generate a transactional content item. So, in some examples, the transactional content item generated via the instructions 606 may be a short-form video (e.g., a “reel”) based on (e.g., modified) a modified content item (e.g., also a short-form video).

In some examples, upon generation of a transactional content item, the instructions 606 may provide a notification (e.g., to an associated user) to inform of the generation of the transactional content item (e.g., “Your video is ready to view.”). In addition, in some examples, the notification provided via the instructions 606 may be provided along with a preview of the transactional content item. Furthermore, in some examples, the instructions 606 may publish the transactional content item to one or more receiving users.

In some examples, a transactional content item generated via the instructions 606 may include various information associated with one or more transactions. That is, in some examples, the transactional content item generated via the instructions 606 may include information that may be directed to facilitating the one or more transactions. Various examples will be provided below.

So, in some examples, the instructions 606 may generate a transactional content item to include one or more interface elements directed to facilitating one or more transactions. In some examples, the one or more interface elements may include a selectable button featuring an item (e.g., a product, a service, etc.) that may be transacted for. In one example where the transactional content item may relate to a dress worn by a social application influencer, the instructions 606 may include a first interface element (e.g., a selectable button) to provide information (e.g., a product details “page” including images, price, user reviews, variations, etc.) about the dress to a receiving user. In addition, the transactional content item may include a second interface element (e.g., a selectable button) to enable the receiving user to initiate a purchase of the dress (e.g., a quantity of items to be purchased). In some examples, upon selection of the second interface element by a receiving user, the instructions 606 may provide a payment transaction (or “checkout”) interface (e.g., including payment method specification, shipping information, etc.) that may enable the receiving user to product the dress. In some examples, the instructions 606 may generate the transactional content item to include a third interface element (e.g., a selectable button) to enable the receiving user to “like” the viewing of the dress. In some examples, one or more of these interface elements may be included in or associated with another interface element (e.g., a floating, rectangular viewing box).

FIG. 6D illustrates a user interface providing generation and publishing of transactional content items based on original content items, according to an example. Specifically, FIG. 6D illustrates one or more interface elements (e.g., a floating viewing box) associated with generating a transactional content item.

FIG. 6E illustrates a user interface providing generation and publishing of transactional content items based on original content items, according to an example. Specifically, FIG. 6E illustrates one or more interface elements associated with a checkout process for generating a transactional content item.

In addition, in some examples, the instructions 606 may provide other types of interface elements in a transactional content item as well. For example, in some instances, where the transactional content item may be associated with a first product or service, the instructions 606 may provide another interface element (e.g., a floating, rectangular viewing box) that may provide a receiving user an opportunity to view one or more other transactional content items (e.g., presented via a “feed” of content items), which may relate to the first product or service or to other products and services.

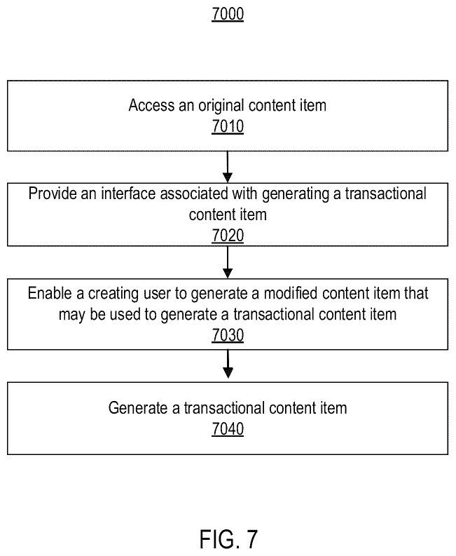

FIG. 7 illustrates a method 7000 for providing generating and publishing of transactional content items based on original content items, according to an example. The method 7000 is provided by way of example, as there may be a variety of ways to carry out the method described herein. Each block shown in FIG. 7 may further represent one or more processes, methods, or subroutines, and one or more of the blocks may include machine-readable instructions stored on a non-transitory computer-readable medium and executed by a processor or other type of processing circuit to perform one or more operations described herein.

Although the method 7000 is primarily described as being performed by system 100C as shown in FIGS. 6A, the method 7000 may be executed or otherwise performed by other systems, or a combination of systems. It should be appreciated that, in some examples, to provide generating and publishing of transactional content items based on original content items, the method 7000 may be configured to incorporate artificial intelligence (AI) or deep learning techniques, as described above. It should also be appreciated that, in some examples, the method 7000 may be implemented in conjunction with a content platform (e.g., a social media platform) to generate and deliver content.

Reference is now made with respect to FIG. 7. At 7010, the processor 101C may access an original content item. In some examples, the original content item accessed via the processor 101C may be utilized to generate a transactional content item as described herein. So, in some examples, the processor 101C may access a long-form video in order to generate a transaction content item associated with one or more products or services.

At 7020, the processor 101C may provide an interface associated with generating a transactional content item. In particular, in some examples, the processor 101C may provide one or more interface elements that may enable a creating user to utilize an original content item (e.g., as accessed via the processor 101C) to generate the transactional content item. In some examples, the processor 101C may determine one or more products or services associated with an original content item that may be a basis of a transactional content item. It may be appreciated that in order to determine one or more products or services associated with an original content item that may be a basis of a transactional content item (e.g., automatically), the processor 101C may be configured to implement one or more aspects of neural networking, artificial intelligence (AI), and machine learning (ML). Also, in some examples, the one or more interface elements may be included a “dashboard” directed to enabling the creating user to generate the transactional content item.

At 7030, the processor 101C may enable a creating user to generate a modified content item that may be used to generate a transactional content item. In some examples and as will be discussed further below, enabling the creating user to generate the modified content item via the processor 101C may include, among other things, providing one or more interface elements that may relate to providing a preview (e.g., audio or video preview) of the modified content item to be generated, providing suggestions of particular portions of an original content item that may be used to generate the modified content item, and enabling a creating user to extract a particular portion of an original content item to generate the modified content item.

In particular, in some examples, the processor 101C may provide one or more user interface elements that may be used to demarcate suggested portions of the original content that may be used to generate the modified content item. In some examples, the user interface elements that may be used to demarcate may take the form of “bars” that may indicate timespans associated with the original content item.

In some examples, the processor 101C may utilize various methods to determine suggested portions of an original content item that may be used to generate a modified content item. It may be appreciated that in order to determine suggested portions of an original content item that may be used to generate a modified content item, the processor 101C may be configured to implement one or more aspects of neural networking, artificial intelligence (AI), and machine learning (ML).

Also, in particular, with regard to enabling a creating user to extract a particular portion of an original content item to generate the modified content item, the processor 101C may provide one or more user interface elements that may be used to (e.g., by a user) modify (e.g., edit, trim, cut, etc.) one or more portions of an original content item to generate the modified content item. In some examples, the user interface elements that may be used to modify may take the form of adjustable “bars” that may correspond to timespans of the original content item.

At 7040, the processor 101C may generate a transactional content item. In some examples, the transactional content item generated via the processor 101C may be based on a modified content item. In other examples, it may be appreciated that the processor 101C may automatically generate the transactional content item in conjunction with one or more neural networking, artificial intelligence (AI), and machine learning (ML) techniques.

In particular, in some examples, the processor 101C may utilize this information to generate a transactional content item. So, in some examples, the transactional content item generated via the processor 101C may be a short-form video based on (e.g., modified) a modified content item (e.g., also a short-form video).

In some examples, upon generation of a transactional content item, the processor 101C may provide a notification (e.g., to an associated user) to inform of the generation of the transactional content item (e.g., “Your video is ready to view.”). In addition, in some examples, the notification provided via the processor 101C may be provided along with a preview of the transactional content item.

So, in some examples, the processor 101C may generate a transactional content item to include one or more interface elements directed to facilitating one or more transactions. In some examples, the one or more interface elements may include a selectable button featuring an item (e.g., a product, a service, etc.) that may be transacted for. In one example where the transactional content item may relate to a dress worn by a social application influencer, the processor 101C may include a first interface element (e.g., a selectable button) to provide information (e.g., a product details “page” including images, price, user reviews, variations, etc.) about the dress to a receiving user. In addition, the transactional content item may include a second interface element (e.g., a selectable button) to enable the receiving user to initiate a purchase of the dress (e.g., a quantity of items to be purchased). In some examples, upon selection of the second interface element by a receiving user, the processor 101C may provide a payment transaction (or “checkout”) interface (e.g., including payment method specification, shipping information, etc.) that may enable the receiving user to product the dress.

In addition, in some examples, the processor 101C may provide other types of interface elements in a transactional content item as well. For example, in some instances, where the transactional content item may be associated with a first product or service, the processor 101C may provide another interface element (e.g., a floating, rectangular viewing box) that may provide a receiving user an opportunity to view one or more other transactional content items (e.g., presented via a “feed” of content items), which may relate to the first product or service or to other products and services.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the systems 100A-100C, the external system 200, and the user devices 300A-300B that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the systems 100A-100C, the external system 200, and the user devices 300A-300B, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the systems 100A-100C, the external system 200, and the user devices 300A-300B, or shared with other systems. Although this disclosure describes using particular privacy settings in a particular manner, this disclosure contemplates using any suitable privacy settings in any suitable manner.

In particular examples, the systems 100A-100C, the external system 200, and the user devices 300A-300B may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the systems 100A-100C, the external system 200, and the user devices 300A-300B may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics.

In particular examples, the systems 100A-100C, the external system 200, and the user devices 300A-300B may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the systems 100A-100C, the external system 200, and the user devices 300A-300B may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The systems 100A-100C, the external system 200, and the user devices 300A-300B may access such information in order to provide a particular function or service to the first user, without the systems 100A-100C, the external system 200, and the user devices 300A-300B having access to that information for any other purposes. Before accessing, storing, or using such objects or information, the systems 100A-100C, the external system 200, and the user devices 300A-300B may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the systems 100A-100C, the external system 200, and the user devices 300A-300B.

In particular examples, a user may specify whether particular types of objects or information associated with the first user may be accessed, stored, or used by the systems 100A-100C, the external system 200, and the user devices 300A-300B. As an example and not by way of limitation, the first user may specify that images sent by the first user through the systems 100A-100C, the external system 200, and the user devices 300A-300B may not be stored by the systems 100A-100C, the external system 200, and the user devices 300A-300B. As another example and not by way of limitation, a first user may specify that messages sent from the first user to a particular second user may not be stored by the systems 100A-100C, the external system 200, and the user devices 300A-300B. As yet another example and not by way of limitation, a first user may specify that all objects sent via a particular application may be saved by the systems 100A-100C, the external system 200, and the user devices 300A-300B.

In particular examples, privacy settings may allow a first user to specify whether particular objects or information associated with the first user may be accessed from the systems 100A-100C, the external system 200, and the user devices 300A-300B. The privacy settings may allow the first user to opt in or opt out of having objects or information accessed from a particular device (e.g., the phone book on a user's smart phone), from a particular application (e.g., a messaging app), or from a particular system (e.g., an email server). The systems 100A-100C, the external system 200, and the user devices 300A-300B may provide default privacy settings with respect to each device, system, or application, and/or the first user may be prompted to specify a particular privacy setting for each context. As an example and not by way of limitation, the first user may utilize a location-services feature of the systems 100A-100C, the external system 200, and the user devices 300A-300B to provide recommendations for restaurants or other places in proximity to the user. The first user's default privacy settings may specify that the systems 100A-100C, the external system 200, and the user devices 300A-300B may use location information provided from one of the user devices 300A-300B of the first user to provide the location-based services, but that the systems 100A-100C, the external system 200, and the user devices 300A-300B may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The systems 100A-100C, the external system 200, and the user devices 300A-300B may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the systems 100A-100C, the external system 200, and the user devices 300A-300B may use a user's previous activities and calculated moods, emotions, or sentiments to determine a present mood, emotion, or sentiment. A user who wishes to enable this functionality may indicate in their privacy settings that they opt in to the systems 100A-100C, the external system 200, and the user devices 300A-300B receiving the inputs necessary to determine the mood, emotion, or sentiment. As an example and not by way of limitation, the systems 100A-100C, the external system 200, and the user devices 300A-300B may determine that a default privacy setting is to not receive any information necessary for determining mood, emotion, or sentiment until there is an express indication from a user that the systems 100A-100C, the external system 200, and the user devices 300A-300B may do so. By contrast, if a user does not opt in to the systems 100A-100C, the external system 200, and the user devices 300A-300B receiving these inputs (or affirmatively opts out of the systems 100A-100C, the external system 200, and the user devices 300A-300B receiving these inputs), the systems 100A-100C, the external system 200, and the user devices 300A-300B may be prevented from receiving, collecting, logging, or storing these inputs or any information associated with these inputs. In particular examples, the systems 100A-100C, the external system 200, and the user devices 300A-300B may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the systems 100A-100C, the external system 200, and the user devices 300A-300B may use the user's mood, emotion, or sentiment to provide newsfeed items, pages, friends, or advertisements to a user. The user may specify in their privacy settings that the systems 100A-100C, the external system 200, and the user devices 300A-300B may determine the user's mood, emotion, or sentiment. The user may then be asked to provide additional privacy settings to indicate the purposes for which the user's mood, emotion, or sentiment may be used. The user may indicate that the systems 100A-100C, the external system 200, and the user devices 300A-300B may use his or her mood, emotion, or sentiment to provide newsfeed content and recommend pages, but not for recommending friends or advertisements. The systems 100A-100C, the external system 200, and the user devices 300A-300B may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the systems 100A-100C, the external system 200, and the user devices 300A-300B may be restricted in its access, storage, or use of the objects or information. The systems 100A-100C, the external system 200, and the user devices 300A-300B may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the systems 100A-100C, the external system 200, and the user devices 300A-300B may temporarily store the message in a content data store until the second user has viewed or downloaded the message, at which point the systems 100A-100C, the external system 200, and the user devices 300A-300B may delete the message from the data store. As another example and not by way of limitation, continuing with the prior example, the message may be stored for a specified period of time (e.g., 2 weeks), after which point the systems 100A-100C, the external system 200, and the user devices 300A-300B may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the systems 100A-100C, the external system 200, and the user devices 300A-300B may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the systems 100A-100C, the external system 200, and the user devices 300A-300B. The user's privacy settings may specify that such information may be used only for particular processes, such as authentication, and further specify that such information may not be shared with any external system or used for other processes or applications associated with the systems 100A-100C, the external system 200, and the user devices 300A-300B. As another example and not by way of limitation, the systems 100A-100C, the external system 200, and the user devices 300A-300B may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the systems 100A-100C, the external system 200, and the user devices 300A-300B. As another example and not by way of limitation, the systems 100A-100C, the external system 200, and the user devices 300A-300B may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the systems 100A-100C, the external system 200, and the user devices 300A-300B.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The systems 100A-100C, the external system 200, and the user devices 300A-300B may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the systems 100A-100C, the external system 200, and the user devices 300A-300B may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the systems 100A-100C, the external system 200, and the user devices 300A-300B may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the systems 100A-100C, the external system 200, and the user devices 300A-300B may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the systems 100A-100C, the external system 200, and the user devices 300A-300B may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the systems 100A-100C, the external system 200, and the user devices 300A-300B may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the systems 100A-100C, the external system 200, and the user devices 300A-300B may send a reminder to the user to confirm his or her privacy settings every six months or after every ten photo posts. In particular examples, privacy settings may also allow users to control access to the objects or information on a per-request basis. As an example and not by way of limitation, the systems 100A-100C, the external system 200, and the user devices 300A-300B may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor; and
a memory storing instructions, which when executed by the processor, cause the processor to:
access a primary content item generated by a first user;
provide a supplemental content item associated with the primary content item;
generate a composite content item based on the primary content item and the supplemental content item;
enable sponsorship by a second user of the composite content item; and
enable publication of the composite content item for playback by a viewing user.

2. The system of claim 1, wherein the instructions when executed by the processor further cause the processor to provide at least one interface element for generating the composite content item.

3. The system of claim 1, wherein the composite content item is a short-form video.

4. The system of claim 1, wherein the supplemental content item is a sticker.

5. The system of claim 1, wherein the supplemental content item is a banner.

6. A system, comprising:
a processor; and
a memory storing instructions, which when executed by the processor, cause the processor to:
access an original content item generated by a first user;
provide at least one interface element associated with generating a transactional content item based on the original content item to the first user;
generate a modified content item based on the original content item using the at least one interface element, the modified content item comprising a supplemental content item;
generate a transactional content item based on the modified content item; and
publish the transactional content item for access by a second user.

7. The system of claim 6, wherein the instructions when executed by the processor further cause the processor to enable a search by the second user to locate the transactional content item.

8. The system of claim 6, wherein the transactional content item is a short-form video and the original content item is an image.

9. The system of claim 6, wherein the supplemental content item is a product description page (PDP).

10. The system of claim 6, wherein the instructions, when executed by the processor, further cause the processor to determine at least one product or service associated with the original content item.

11. A method for generating content items, comprising:
accessing a primary content item generated by a first user;
providing a supplemental content item associated with the primary content item;
generating a composite content item based on the primary content item and the supplemental content item;
enabling sponsorship by a second user of the composite content item; and
enabling publication of the composite content item for playback by a viewing user.

12. The method of claim 11, further comprising providing at least one interface element for generating the composite content item.

13. The method of claim 11, wherein the composite content item is a short-form video.

14. The method of claim 11, wherein the supplemental content item is a banner.

15. The method of claim 11, wherein the supplemental content item is a sticker.
